(19) United States
(12) Patent Application Publication
(10) Pub. No.: US 2009/0246415 A1
(43) Pub. Date: Oct. 1, 2009

(54) FUNCTIONAL FILM AND DISPLAY APPARATUS

(76) Inventors: Wataru HORIE, Osaka (JP); Mitsuaki Kumazawa, Kitakyusyu-shi (JP); Shinji Kikuchi, Himeji-shi (JP)

Correspondence Address: BIRCH STEWART KOLASCH & BIRCH, PO BOX 747, FALLS CHURCH, VA, 22040-0747, US

(21) Appl. No.: 12/413,347

(22) Filed: Mar. 27, 2009

(30) Foreign Application Priority Data
Mar. 28, 2008 (JP) 088493/2008

(51) Int. Cl. C09K 19/38; B05D 5/06; B05D 3/06; B32B 23/00; B32B 3/00; B32B 27/00; B32B 27/36; B32B 3/26; B32B 5/16; B32B 15/08; B32B 7/02

(52) U.S. Cl. 428/1.3; 427/162; 427/595; 428/532; 428/156; 428/500; 428/480; 428/319.3; 428/323; 428/457; 428/212; 428/213; 977/773

(57) ABSTRACT

A functional film comprises an anti-glare layer and an anti-reflection layer formed on the anti-glare layer. In the functional film, the anti-glare layer comprises a resin component comprising a plurality of resins which phase-separate from each other, the anti-reflection layer has a first surface and a second surface contacting with the anti-glare layer and comprises a low-refractive-index particle and a high-refractive-index particle, and the high-refractive-index particle is localized near the second surface of the anti-reflection layer.

### FIELD OF THE INVENTION

The present invention relates to a functional film suitably used in liquid crystal displays for various devices or systems such as computers, word processors, and televisions, a process for producing the functional film, and a display apparatus (a liquid crystal display apparatus) provided with (or equipped with) the functional film.

### BACKGROUND OF THE INVENTION

In these days, liquid crystal displays have improved remarkably as a display apparatus for television (TV) application or movie display application, and the liquid crystal displays rapidly become popular. The reason for that is, for example, the development of a liquid crystal material having a high-speed responsiveness or the improvement of a drive system such as overdrive has overcome a poor movie display performance, which has been a persistent drawback of liquid crystal displays, and the innovation of industrial technology coping or dealing with the increase in display size has progressed.

These displays are usually subjected to a surface treatment for inhibiting reflection of an ambient light (sun light or light form a light source around an apparatus provided with the display) on a surface in order to use the displays for an application requiring a high image quality (e.g., a television and a monitor) and an application in which the displays are used in open air under a strong ambient light (e.g., a video camera). One of the means for inhibiting reflection of an ambient light is an anti-glare treatment. For example, a surface of a liquid crystal display is usually subjected to the anti-glare treatment. By the anti-glare treatment, a finely uneven structure is formed on the surface of the display so as to scatter a light reflected from the surface and blurring of a reflected image on the surface. Therefore, unlike a clear anti-reflection film, the anti-glare layer inhibits the reflected images of viewer and background, and the light reflected on the anti-glare layer hardly tends to interfere with a projected image.

For example, Japanese Patent Application Laid-Open No. 337734/1999 (JP-11-337734A; Claims 1, 4, and 8, and Paragraph No. [0001]) discloses an antiglare-treated layer having an uneven structure on a surface thereof, the layer being used as a surface-treated layer formed on a surface of a polarizing film being preferable for a material of a liquid crystal cell. This document mentions that the antiglare-treated layer is formed by coating (e.g., spin-coating) a resin solution in which fine particle having a high refractive index (or refraction index) are dispersed, or by coating (e.g., spin-coating) only an acrylic resin and then directly imparting irregularity to the surface mechanically or chemically.

Japanese Patent Application Laid-Open No. 215307/2001 (JP-2001-215307A; Claim 1 and Paragraph No. [0012]) discloses an anti-glare layer containing a transparent fine particle having a mean particle size of 15 μm in a coat layer whose thickness is not less than twice of the mean particle size, wherein the anti-glare layer has a surface having a finely uneven structure through unevenly distributing the transparent fine particle in one side being in touch with air of the coat layer.

However, it is difficult to make the refractive indices of the fine particle and the resin uniform. Therefore, such an anti-glare layer has an internal haze due to light scattered by the fine particle, in addition to a haze due to the uneven surface structure. The internal haze causes the scatter of the ambient light in the anti-glare layer, whereby a display provided with the anti-glare layer presents a black image which is substantially whitish (which has a whitening) and a decreased light-room contrast. In particular, in the television (TV) application, the recent home theater boom serves as a tail wind for requirement of a contrasty projected image in which black is sharper or clearer.

Japanese Patent Application Laid-Open No. 27920/1995 (JP-7-27920A; Claims 1 and 3, and Paragraph Nos. [0001] and [0020]) discloses a polyethylene terephthalate film for attaching to a polarizing plate which is used for a surface of various displays such as word processors, computers and televisions, particularly liquid crystal displays, wherein the polyethylene terephthalate film is antiglare-treated by patterning of a pre-patterned film having a finely uneven structure on a surface thereof. This document describes that the anti-glare layer having a finely uneven structure on a surface thereof is obtained by coating an ionizing radiation-curable resin composition on the polyethylene terephthalate film, laminating a patterned matt film having a finely uneven structure on a surface thereof on the coated resin composition in the uncured state, irradiating ionizing radiation on the laminated matter to completely cure the coat, and separating the patterned matt film from the completely cured coat.

However, a method using such a patterned film has the following shortcomings. Since it is difficult to produce such a matt patterned film itself, the anti-glare film is not suitable for high-volume production. Further, it has been also known that such an artificial regular pattern or arrangement of the surface of the anti-glare layer inescapably causes an interference of the reflected light, and then induces moire pattern (formation of a rainbow pattern).

Japanese Patent Application Laid-Open No. 126495/2004 (JP-2004-126495A; Claims 1 and 21, and Paragraph No. [0090]) discloses an anti-glare film comprising at least an anti-glare layer, wherein the anti-glare layer has an uneven structure on a surface thereof, and the anti-glare film isotropically transmits and scatters an incident light to show the maximum value of the scattered light intensity at a scattering angle of 0.1 to 10°, and has a total light transmittance of 70 to 100%. This document describes that, in a process which comprises preparing a solution of at least one polymer and at least one curable resin precursor uniformly dissolved in a solvent and evaporating the solvent from the solution to produce a sheet, spinodal decomposition under an appropriate condition followed by curing the precursor ensures a phase-separation structure having regularity and an uneven surface structure corresponding to the phase-separation structure. The document also teaches that attachment of such an anti-glare layer having a regular phase-separation structure to a display apparatus ensures a clear image quality without blur images of characters and concurrently realizes good anti-glare effects without washing out or whitening (white blur). Further, this document mentions that attachment of the film to a high-definition display apparatus effectively eliminates dazzle in the display surface and ensures high-performance anti-glaring function.

However, the anti-glare film mentioned above has drawbacks as follows. After a light passes through the surface of a liquid crystal panel with the anti-glare film, part of the incident light is reflected by an ITO electrode or a wiring electrode comprising a TFT element, which is a pixel of the liquid crystal panel. When the reflected light moves back to the surface, blue color of the reflected light is partly absorbed in the ITO electrode or the wiring electrode. Therefore the reflected light (or an image on the display) becomes yellowish. In addition, the control of the phase separation in the production process is difficult. Since the size of the phase separation is greatly affected by a slight difference in a lot quality of a raw material, a polymer composition, or the like, the stable production of the anti-glare sheet is difficult.

In addition, Japanese Patent Application Laid-Open No. 86764/2007 (JP-2007-86764A; Claims, and Paragraph Nos. [0095], [0108], and [0115]) discloses an optical film comprising a transparent plastic film substrate and a cured layer, having a dry thickness of not less than 100 nm, formed on the substrate. In the optical film, the cured layer is formed by coating a curable composition containing a low-refractive-index fine particle having a refractive index of not larger than 1.50 (e.g., a hollow silica particle) and a binder resin, and the low-refractive-index fine particle accumulates or gathers near a surface of the cured layer opposite the substrate.

The document states as follows: the cured layer serves as a hardcoat layer having an anti-reflective property and abrasion resistance; the hardcoat layer is formed from a curable composition; the curable composition may contain a mat particle for imparting anti-glareness or internal scattering property to the layer and an inorganic fine particle for imparting a high refractive index and a high strength to the layer and inhibiting a crosslinking contraction of the layer [for example, TiO₂, ZrO₂, Al₂O₃, In₂O₃, ZnO, SnO₂, Sb₂O₃, and an indium oxide which is doped with tin (ITO)], in addition to the low-refractive-index fine particle and the binder resin for imparting a hardcoat property to the layer; and the high-refractive-index fine particle is preferably dispersed in a thickness direction of the cured layer with increasing the concentration thereof toward the substrate while the low-refractive-index fine particle is dispersed in a thickness direction of the cured layer with decreasing the concentration thereof toward the substrate.

The film described in the document can achieve not only an anti-reflection property but also anti-glareness with the cured layer alone, which is a single layer, owing to the mat particle contained in the single layer. However, in order to provide the anti-glareness, it is necessary to protrude the mat particle having a particle diameter as large as about several micrometers from the surface of the cured layer. Therefore, since the localization of the low-refractive-index particle near the surface of the cured layer is insufficient, the film has an insufficient anti-reflection property. Moreover, cohesion between the mat particle and the low-refractive-index particle sometimes deteriorates the anti-reflective performance.

Moreover, Japanese Patent Application Laid-Open No. 359930/2004 (JP-2004-359930A; Claims, and Paragraph Nos. [0006], and [0039]) discloses a cured film obtained by curing a liquid resin composition. The composition comprises (A) a fluorine-containing polymer, (B) a curable compound (for example, a melamine-series compound, a urea-series compound, a benzoguanamine-series compound, and a glycoluril-series compound), (C) a metal oxide particle having a mean particle diameter of not more than 100 nm (e.g., a particle comprising one or more metal oxides selected from the group consisting of a titanium oxide, a zirconium oxide, an antimony-containing tin oxide, a tin oxide-containing indium, a silicon dioxide, an aluminum oxide, a cerium oxide, a zinc oxide, a tin oxide, an antimony-containing zinc oxide, and an indium-containing zinc oxide, as a main component), and (D) a solvent. According to the process described in the document, a cured film having two layers can be formed. One of the layers has the component (C) in a high density, and another layer is substantially free from the component (C) or has the component (C) in a low density.

However, since the cured film is obtained by coating a clear substrate with the liquid resin composition according to the process described in the document, when the cured film is applied on or attached to a display, the cured film cannot scatter a light reflected at the surface thereof. Accordingly, the reflection of a shape of an object in a background or an ambient light on the display cannot be prevented. The reflected light deteriorates an image appearing on the display and decreases a light-room contrast. In particular, in the television (TV) application, the recent home theater boom serves as a tail wind for requirement of a contrasty projected image in which black is sharp. Further, the formation of the low-refractive layer due to the phase separation generates a wide refractive index difference between the low-refractive layer and high-refractive layer. Since reflectance (reflectivity) depends on the wave length of incident light, when a light enters on the film having such a structure, the reflected light does not have a neutral color.

Moreover, Japanese Patent Application Laid-Open No. 235198/2006 (JP-2006-235198A, Claims, and Paragraph Nos. [0066] and [0067]) discloses an optical film comprising a support and a thin film layer formed thereon by coating a composition containing a fine particle (e.g., a hollow silica) and a binder. The optical film has a SP value [(B/A)×100], which is an average ratio of (B) an average particle filling factor relative to (A) an average particle filling factor, of not less than 90% and not more than 333%, where the average particle filling factor (A) is an average particle filling factor in the entirety of the thin film layer, and the average particle filling factor (B) is an average particle filling factor in a region of 30% of a film thickness of the thin film layer on the upper side opposite the support.

This document mentions that the optical film has a transparent support and, if necessary, a hardcoat layer as mentioned below, and one or more layer(s) laminated on the support or hardcoat layer according as factors such as the refractive index, the film thickness, the number of layers and the order of laminating layers so as to reduce a reflectance by optical interference. The document also discloses that the simplest construction of the low-refractive-index layer d product comprises the support and a low-refractive-index layer alone coated thereon. The document teaches a support film/anti-glare layer/high-refractive-index layer/low-refractive-index layer construction, and others, as concrete layer constructions. However, for the film having such a layer construction, in order to form the low-refractive-index layer, a composition for the low-refractive-index layer is coated on the high-refractive-index layer which had been already formed. Since the high-refractive-index layer has an uneven surface, forming the low-refractive-index layer into a shape conforming to the uneven surface of the high-refractive-index layer is impossible. Therefore, the optical film has a high reflectance, and when the film is attached to a display, the light-room contrast is possibly decreased.

Furthermore, Japanese Patent Application Laid-Open No. 293313/2007 (JP-2007-293313A, Claims, and Paragraph Nos. [0153] and [0171] to [0173]) discloses as follows: a coating composition comprising a first resin component which can form a cured layer having a surface free energy of not more than 30 mN/m and a second resin component which can cure the first resin, a first inorganic fine particle having a mean particle diameter of not less than 2 nm to not more than 100 nm (e.g., an inorganic fine particle comprising an oxide of at least one metal selected from the group consisting of titanium, zirconium, aluminum, indium, zinc, tin, and antimony, as a main component), and at least one organic solvent, the first component and/or the second resin component having a functional group curable with an ionizing radiation, and the coating composition being hardened to form a cured layer having an upper surface and a lower surface and an upper region near the upper surface and a lower region near the lower surface which are different in refractive index by localizing the inorganic particle near the lower surface; an optical film comprising a transparent support and a cured layer obtained by curing the coating composition on the transparent support; and an optical film having the cured layer mentioned above having a low-refractive-index region as an outer-most layer and a high-refractive-index region adjacent to the low-refractive-index region. This document mentions that in order to allow the lower region to be a low-reflection layer when the first inorganic fine particle is localized in the lower region in the cured layer, the first inorganic fine particle preferably has a high refractive index, and the preferred refractive index was 1.60 to 3.00. In addition, the document describes as follows: it is preferred that the coating composition comprises an inorganic fine particle preferably having a refractive-index of not more than 1.46, more preferably about 1.17 to 1.46 as a second inorganic fine particle; since in the cured layer, the second fine particle are localized an upper region to improve abrasion resistance and decrease refractive index of the film, the second inorganic fine particle has preferably a low refractive index and is a silica fine particle; and the preferred mean particle diameter is not less than 10 nm to not more than 100 nm and the preferred structure is a hollow structure.

Moreover, this document teaches that the above-mentioned optical film comprises the cured layer serving as a plurality of functional layers concurrently and may further comprise other functional layers according to need, in addition to the low-refractive-index layer. The document describes that a preferred embodiment of the optical film is an anti-reflection film which comprises a transparent support 1, a layer having hardcoat property (hardcoat layer) 2, a middle-refractive-index layer 3, a high-refractive-index layer 4, a low-refractive-index layer (outermost layer) 5 in this order. In addition, the document discloses as follows: the haze of the hardcoat layer depends on what function is imparted to the anti-reflection film; and in the case of a hardcoat layer which comprises a translucent particle for imparting inner scattering property to the film, the internal haze of the film is preferably 0 to 60%. However, the optical film (anti-reflection film) described in the document has a drawback. Such a film causes a light scattering at an interface of the resin and the particle when the film is attached to the display, whereby black image on the display becomes blurred.

### SUMMARY OF THE INVENTION

It is therefore an object of the present invention to provide a functional film having a high anti-glareness and anti-reflection property, a process for producing the functional film, and a display apparatus provided with the functional film (e.g., a liquid crystal display apparatus).

Another object of the present invention is to provide a functional film which can prevent a reflection of an ambient light and glare and provide a black image (a high light-room contrast image) even under an ambient light when the film is attached to a display, a process for producing the functional film, and a display apparatus provided with the functional film (e.g., a liquid crystal display apparatus).

A further object of the present invention is provide to a functional film which has a high front side contrast and front side brightness (or luminance) and allows a light reflected on the display to be a neutral (or natural) tone color, a process for producing the functional film, and a display apparatus provided with the functional film (e.g., a liquid crystal display apparatus).

### MEANS TO SOLVE THE PROBLEMS

The inventors of the present invention made intensive studies to achieve the above objects and finally found that a functional film achieving a high level anti-glare property and anti-reflection property efficiently and having an anti-glare layer and an anti-reflection layer having a first surface and a second surface contacting with the anti-glare layer is obtained by applying a coating liquid composition containing a low-refractive-index particle (e.g., a hollow particle such as a hollow silica particle) and a high-refractive-index particle (e.g., an ATO particle) on an anti-glare layer having an internal haze as minimized as possible with an aid of the phase separation (in particular, an anti-glare layer having an uneven surface formed with an aid of a self-ordering phenomenon (cellular rotating convection phenomenon and phase-separation phenomenon) of a polymer solution). The reason for achieving the high anti-glare property and anti-reflection property is forming (or laminating) the anti-reflection layer in which the low-refractive-index particle is localized near the first surface of the anti-reflection layer, and the high-refractive-index particle is localized near the second surface of the anti-reflection layer adjacent to the anti-glare layer, on the anti-glare layer by applying the coating liquid composition on the anti-glare layer. The inventors also found that when such a functional film is applied on a display, the functional film prevents the reflection and even under an ambient light, display a black image (an image having a high light-room contrast) on the display. The present invention was accomplished based on the above findings.

That is, the functional film of the present invention is a functional film comprising an anti-glare layer and an anti-reflection layer formed on the anti-glare layer. The anti-glare layer comprises a resin component comprising a plurality of resins which phase-separate from each other, the anti-reflection layer has a first surface and a second surface contacting with the anti-glare layer and comprises a low-refractive-index particle and a high-refractive-index particle, and the high-refractive-index particle is localized near the second surface of the anti-reflection layer.

The anti-glare layer mentioned above is a cured layer obtained by curing a coating layer comprising a resin component and a curable resin and may have an uneven surface structure.

The above-mentioned plurality of resins may comprise at least a cellulose derivative. Moreover, at least one polymer of the plurality of resins may be a polymer having a functional group reactive with a curable resin. A representative example of the plurality of resins may comprise a cellulose ester and a resin which has a functional group reactive with a curable resin at a side chain thereof and is at least one resin selected from the group consisting of a methacrylic resin, an acrylic resin, an alicyclic olefinic resin, and a polyester-series resin.

The low-refractive-index particle may comprise a hollow particle (particularly a hollow silica particle). Moreover, the low-refractive-index particle mentioned above may have a mean particle diameter of 50 to 70 nm and a refractive index of 1.20 to 1.25.

The above-mentioned high-refractive-index particle may comprise at least one member selected from the group consisting of an antimony-containing tin oxide (ATO) particle and an antimony(V) oxide particle (antimony(V) oxide (Sb₂O₅) particle). In addition, the high-refractive-index particle may have a mean particle diameter of 5 to 30 nm and a refractive index of 1.60 to 1.80.

In the above-mentioned anti-reflection layer, the weight ratio of the low-refractive-index particle relative to the high-refractive-index particle [former/latter] may be 93/7 to 50/50.

In the functional film of the present invention, the low-refractive-index particle may usually be localized near the first surface of the anti-reflection layer and the high-refractive-index particle may usually be localized near the second surface of the anti-reflection layer. In particular, the anti-reflection layer may have a high-refractive-index region formed by the high-refractive-index particle localized near the second surface of the anti-reflection layer and a low-refractive-index region formed by the low-refractive-index particle localized near the first surface of the anti-reflection layer. The thickness of the high-refractive-index region may be about 5 to 40 nm, and the thickness of the low-refractive-index region may be about 90 to 120 nm. In particular, the above-mentioned high-refractive-index region may comprise the low-refractive-index particle. Therefore, in such a functional film, the change in refractive index of the anti-reflection layer can be moderate. Furthermore, the anti-reflection layer may comprise a low-refractive-index resin as a resin component or a film-forming resin. The low-refractive-index resin may comprise a curable resin [e.g., a curable resin having a methacryloyl group or an acryloyl group].

Incidentally, the functional film of the present invention may be a functional film used for a display apparatus (e.g., a display apparatus selected from the group consisting of a liquid crystal display, a self-luminous display, and a plasma display).

The present invention also includes a process for producing the above-mentioned functional film, which comprises a coating step for coating a substrate film having the anti-glare layer formed thereon with a liquid coating composition containing a low-refractive-index particle and a high-refractive-index particle and a drying step for drying the resulting coating layer. In such a process, the liquid coating composition further comprising a curable resin as a low-refractive-index resin may be used, and the process may further comprise a step for curing the dried coating layer by irradiating with one selected form the group consisting of an actinic ray and heat.

Moreover, the present invention includes a display apparatus provided with the above-mentioned functional film. Such a display apparatus may be a display apparatus selected from the group consisting of a liquid crystal display, a self-luminous display, and a plasma display. The liquid crystal display apparatus mentioned above may further comprise a prism sheet containing a prism unit having an approximately isosceles triangular cross-section.

Further, the present invention includes an optical member comprising a polarizing plate and the above-mentioned functional film laminated (or formed) on at least one surface of the polarizing plate. Incidentally, in the description, the term “a (meth)acrylic resin” means a methacrylic resin and/or an acrylic resin and the term “a (meth)acryloyl group” means a methacryloyl group and/or an acryloyl group.

### BRIEF DESCRIPTION OF THE DRAWINGS

FIG. 1 is a schematic cross-sectional view of an optical member comprising a functional film in accordance with an embodiment of the present invention and a polarizing plate on which the functional film is formed.

FIG. 2 is a schematic cross-sectional view of a liquid crystal panel produced in Examples.

FIG. 3 is a schematic cross-sectional view of a liquid crystal display apparatus produced in Examples.

FIG. 4 is a perspective view of a prism sheet used in Example 2 and Comparative Example 2.

FIG. 5 is a perspective view of a backlight source used in Examples.

FIG. 6 is a laser reflection microphotograph of an uneven surface structure of a functional film obtained in Example 1.

FIG. 7 is a transmission electron microphotograph (TEM) of a cross section of a functional film obtained in Example 1.

### DETAILED DESCRIPTION OF THE INVENTION

### Functional Film

The functional film of the present invention comprises an anti-glare layer and an anti-reflection layer (anti-reflection film)formed on the anti-glare layer. The anti-glare layer comprises a resin component comprising a plurality of resins which phase-separate from each other and the anti-reflection layer (anti-reflection film) comprises a low-refractive-index particle and a high-refractive-index particle. The functional film may usually comprise a substrate (a substrate film or sheet, or a support film or sheet), an anti-glare layer formed on the substrate, and an anti-reflection layer formed on the anti-glare layer.

[Substrate]

A support having light transmittance properties, for example, a transparent support such as a synthetic resin film may usually be employed as the substrate (substrate film). Such a support having light transmittance properties may comprise a transparent polymer film for forming an optical member.

The transparent support (substrate sheet) may include, for example, a resin sheet (a resin film) in addition to a glass (substrate) and a ceramic (substrate). The same resins as those constituting an anti-glare layer as described later may be used as a resin constituting the transparent support.

The preferred transparent support includes a transparent polymer film, for example, a film formed from a cellulose derivative [e.g., a cellulose acetate such as a cellulose triacetate (TAC) or a cellulose diacetate], a polyester-series resin [e.g., a poly(ethylene terephthalate) (PET), a poly(butylene terephthalate) (PBT), and a polyarylate-series resin], a polysulfone-series resin [e.g., a polysulfone and a polyethersulfone (PES)], a polyetherketone-series resin [e.g., a polyetherketone (PEK) and a polyetheretherketone (PEEK)], a polycarbonate-series resin (PC), a polyolefinic resin (e.g., a polyethylene and a polypropylene), a cyclic polyolefinic resin (e.g., the trade name “ARTON”, the trade name “ZEONEX”, and the trade name “TOPAS”), a halogen-containing resin (e.g., a poly(vinylidene chloride)), a (meth)acrylic resin, a styrenic resin (e.g., a polystyrene), a vinyl acetate-or vinyl alcohol-series resin (e.g., a poly(vinyl alcohol)), or others. The transparent support may be stretched monoaxially or biaxially, and the transparent support having optical isotropy is preferred. The preferred transparent support is a support sheet or film having a low birefringence index. The optically isotropic transparent support may include a non-stretched sheet or film, for example, a sheet or film formed from a polyester (e.g., a PET and a PBT), a cellulose ester, in particular a cellulose acetate (e.g., a cellulose acetate such as a cellulose diacetate or a cellulose triacetate, a cellulose acetate C₃₋₄acylate such as a cellulose acetate propionate or a cellulose acetate butyrate) or the like. The thickness of the support (e.g., the resin film) having a two-dimensional structure may be selected within the range of, for example, about 5 to 2000 μm, preferably about 15 to 1000 μm, and more preferably about 20 to 500 μm.

### [Anti-Glare Layer]

The anti-glare layer comprises (is formed from) a resin component (thermoplastic resin component) comprising a plurality of resins which phase-separate from each other (usually, thermoplastic resins). In particular, the anti-glare layer may be a cured layer formed by curing a coating layer containing a curable resin (curable resin precursor), in addition to the resin component, in order to improve hardcoat property (abrasion resistance) of the anti-glare layer or impart hardcoat property (abrasion resistance) to the anti-glare layer. Therefore, a regular or periodical uneven surface structure, which is described later, is easily imparted to such an anti-glare layer and is fixed by curing the curable resin.

(Resin Component)

The resin component is not particularly limited to a specific one as long as a plurality of resins which phase-separate from each other (or incompatible with each other) are contained in the resin component. The resins are sometimes referred to as polymer components or polymers. Incidentally, the resins which phase-separate from each other at or around a processing temperature may be used in combination.

The polymer component may usually comprise a thermoplastic resin. The thermoplastic resin may include, for example, a styrenic resin, a (meth)acrylic resin, an organic acid vinyl ester-series resin, a vinyl ether-series resin, a halogen-containing resin, an olefinic resin (including an alicyclic olefinic resin), a polycarbonate-series resin, a polyester-series resin, a polyamide-series resin, a thermoplastic polyurethane resin, a polysulfone-series resin (e.g., a polyethersulfone and a polysulfone), a poly(phenylene ether)-series resin (e.g., a polymer of 2,6-xylenol), a cellulose derivative (e.g., a cellulose ester, a cellulose carbamate, and a cellulose ether), a silicone resin (e.g., a polydimethylsiloxane and a polymethylphenylsiloxane), a rubber or elastomer (e.g., a diene-series rubber such as a polybutadiene or a polyisoprene, a styrene-butadiene copolymer, an acrylonitrile-butadiene copolymer, an acrylic rubber, a urethane rubber, and a silicone rubber), and the like. These thermoplastic resins may be used singly or in combination.

The styrenic resin may include a homo- or copolymer of a styrenic monomer (e.g. a polystyrene, a styrene-α-methylstyrene copolymer, and a styrene-vinyl toluene copolymer), and a copolymer of a styrenic monomer and other polymerizable monomers [e.g., a (meth)acrylic monomer, maleic anhydride, a maleimide-series monomer, and a diene]. The styrenic copolymer may include, for example, a styrene-acrylonitrile copolymer (AS resin), a copolymer of styrene and a (meth)acrylic monomer [e.g., a styrene-methyl methacrylate copolymer, a styrene-methyl methacrylate-(meth)acrylate copolymer, and a styrene-methylmethacrylate-(meth)acrylic acid copolymer], and a styrene-maleic anhydride copolymer. The preferred styrenic resin includes a polystyrene, a copolymer of styrene and a (meth)acrylic monomer [e.g., a copolymer comprising styrene and methyl methacrylate as main units, such as a styrene-methyl methacrylate copolymer], an AS resin, a styrene-butadiene copolymer, and the like.

The (meth)acrylic resin to be used may include a homo- or copolymer of a (meth) acrylic monomer and a copolymer of a (meth)acrylic monomer and a copolymerizable monomer. The (meth)acrylic monomer may include, for example, (meth)acrylic acid; a C₁₋₁₀alkyl (meth)acrylate such as methyl (meth)acrylate, ethyl (meth)acrylate, butyl (meth)acrylate, t-butyl (meth)acrylate, isobutyl (meth)acrylate, hexyl (meth)acrylate, octyl (meth)acrylate, or 2-ethylhexyl (meth)acrylate; an aryl (meth)acrylate such as phenyl (meth)acrylate; a hydroxyalkyl (meth)acrylate such as hydroxyethyl (meth)acrylate or hydroxypropyl (meth)acrylate; glycidyl (meth)acrylate; an N,N-dialkylaminoalkyl (meth)acrylate; (meth)acrylonitrile; and a (meth)acrylate having an alicyclic hydrocarbon group such as tricyclodecane. The copolymerizable monomer may include the above styrenic monomer, a vinyl ester-series monomer, maleic anhydride, maleic acid, and fumaric acid. These monomers may be used singly or in combination.

The (meth)acrylic resin may include, for example, a poly(meth)acrylate such as a poly(methyl methacrylate), a methyl methacrylate-(meth)acrylic acid copolymer, a methyl methacrylate-(meth)acrylate copolymer, a methyl methacrylate-acrylate-(meth)acrylic acid copolymer, and a (meth)acrylate-styrene copolymer (MS resin). The preferred (meth)acrylic resin includes a poly(C₁₋₆alkyl (meth)acrylate) such as a poly(methyl(meth)acrylate). In particular, a methyl methacrylate-series resin containing methyl methacrylate as a main component (about 50 to 100% by weight, and preferably about 70 to 100% by weight) is preferred.

The organic acid vinyl ester-series resin may include a homo- or copolymer of a vinyl ester-series monomer (e.g., a poly(vinyl acetate) and a poly(vinyl propionate)), a copolymer of a vinyl ester-series monomer and a copolymerizable monomer (e.g., an ethylene-vinyl acetate copolymer, a vinyl acetate-vinyl chloride copolymer, and a vinyl acetate-(meth)acrylate copolymer), or a derivative thereof. The derivative of the vinyl ester-series resin may include a poly(vinyl alcohol), an ethylene-vinyl alcohol copolymer, a poly(vinyl acetal) resin, and the like.

The vinyl ether-series resin may include a homo- or copolymer of a vinyl C₁₋₁₀alkyl ether such as vinyl methyl ether, vinyl ethyl ether, vinyl propyl ether, or vinyl t-butyl ether, and a copolymer of a vinyl C₁₋₁₀alkyl ether and a copolymerizable monomer (e.g., a vinyl alkyl ether-maleic anhydride copolymer).

The halogen-containing resin may include a poly(vinyl chloride), a poly(vinylidene fluoride), a vinyl chloride-vinyl acetate copolymer, a vinyl chloride-(meth)acrylate copolymer, a vinylidene chloride-(meth)acrylate copolymer, and the like.

The olefinic resin may include, for example, an olefinic homopolymer such as a polyethylene or a polypropylene, and a copolymer such as an ethylene-vinyl acetate copolymer, an ethylene-vinyl alcohol copolymer, an ethylene-(meth)acrylic acid copolymer, or an ethylene-(meth)acrylate copolymer. Examples of the alicyclic olefinic resin may include a homo- or copolymer of a cyclic olefin such as norbornene or dicyclopentadiene (e.g., a polymer having an alicyclic hydrocarbon group such as tricyclodecane which is sterically rigid), a copolymer of the cyclic olefin and a copolymerizable monomer (e.g., an ethylene-norbornene copolymer and a propylene-norbornene copolymer). The alicyclic olefinic resin is available as, for example, the trade name “ARTON”, the trade name “ZEONEX”, the trade name “TOPAS”, and the like.

The polycarbonate-series resin may include an aromatic polycarbonate based on a bisphenol (e.g., bisphenol A), an aliphatic polycarbonate such as diethylene glycol bisallyl carbonate, and others.

The polyester-series resin may include an aromatic polyester obtainable from an aromatic dicarboxylic acid such as terephthalic acid [for example, a homopolyester, e.g., a poly(C₂₋₄alkylene terephthalate) such as a poly(ethylene terephthalate) or a poly(butylene terephthalate), a poly(C₂₋₄alkylene naphthalate), and a copolyester comprising a C₂₋₄alkylene arylate unit (a C₂₋₄alkylene terephthalate unit and/or a C₂₋₄alkylene naphthalate unit) as a main component (e.g., not less than 50% by weight)]. The copolyester may include a copolyester in which one or some of C₂₋₄alkylene glycols constituting a poly(C₂₋₄alkylene arylate) is substituted with a poly(oxyC₂₋₄alkylene glycol), a C₆₋₁₀alkylene glycol, an alicyclic diol (e.g., cyclohexane dimethanol and hydrogenated bisphenol A), a diol having an aromatic ring (e.g., 9,9-bis(4-(2-hydroxyethoxy)phenyl)fluorene having a fluorenone side chain, a bisphenol A, and a bisphenol A-alkylene oxide adduct) or the like, and a copolyester in which one or some of aromatic dicarboxylic acids as constituting units is substituted with an unsymmetric aromatic dicarboxylic acid such as phthalic acid or isophthalic acid, an aliphatic C₆₋₁₂dicarboxylic acid such as adipic acid, or the like. The polyester-series resin may also include a polyarylate-series resin, an aliphatic polyester obtainable from an aliphatic dicarboxylic acid such as adipic acid, and a homo- or copolymer of a lactone such as ε-caprolactone. The preferred polyester-series resin is usually a non-crystalline resin, such as a non-crystalline copolyester (e.g., a C₂₋₄alkylene arylate-series copolyester).

The polyamide-series resin may include a polyamide obtainable from a dicarboxylic acid (e.g., terephthalic acid, isophthalic acid, and adipic acid) and a diamine (e.g., hexamethylenediamine and metaxylylenediamine, a polyamide obtainable from a lactam such as ε-caprolactam, and others. The polyamide is not limited to a homopolyamide but may be a copolyamide. The representative polyamide-series resin includes, for example, an aliphatic polyamide resin such as a polyamide 46, a polyamide 6, a polyamide 66, a polyamide 610, a polyamide 612, a polyamide 11, or a polyamide 12.

Among the cellulose derivatives, the cellulose ester may include, for example, a fatty acid ester of a cellulose (e.g., a C₁₋₆oraganic acid ester of a cellulose such as a cellulose acetate (e.g., a cellulose diacetate and a cellulose triacetate), a cellulose propionate, a cellulose butyrate, a cellulose acetate propionate, or a cellulose acetate butyrate), an aromatic carboxylic acid ester of a cellulose (e.g. a C₇₋₁₂aromatic carboxylic acid ester of a cellulose such as a cellulose phthalate or a cellulose benzoate), an inorganic acid ester of a cellulose (e.g., a cellulose phosphate and a cellulose sulfate) and may be a mixed acid ester of a cellulose such as a cellulose acetate nitrate. The cellulose derivative may also include a cellulose carbamate (e.g. a cellulose phenylcarbamate), a cellulose ether (e.g., a cyanoethylcellulose; a hydroxyC₂₋₄alkyl cellulose such as a hydroxyethyl cellulose or a hydroxypropyl cellulose; a C₁₋₆alkyl cellulose such as a methyl cellulose or an ethyl cellulose; a carboxymethyl cellulose or a salt thereof, a benzyl cellulose, and an acetyl alkyl cellulose).

The preferred thermoplastic resin includes, for example, a styrenic resin, a (meth)acrylic resin, a vinyl acetate-series resin, a vinyl ether-series resin, a halogen-containing resin, an alicyclic olefinic resin, a polycarbonate-series resin, a polyester-series resin, a polyamide-series resin, a cellulose derivative, a silicone-series resin, and a rubber or elastomer, and the like. The thermoplastic resin to be usually employed includes a resin that is non-crystalline and is soluble in an organic solvent (particularly a common solvent for dissolving a plurality of polymers and curable compounds). In particular, a resin that has an excellent moldability or film-forming (film-formable) properties, transparency, and weather resistance [for example, a styrenic resin, a (meth)acrylic resin, an alicyclic olefinic resin, a polyester-series resin, and a cellulose derivative (e.g., a cellulose ester)] is preferred. In particular, in the present invention, it is preferable that at least the cellulose derivative be used as the thermoplastic resin. Since the cellulose derivative is a semisynthetic polymer and is different in dissolution behavior from other resins or curable resins, the cellulose derivative has a very good phase separability.

A polymer having a functional group participating (or being involved) in a curing reaction (or a functional group capable of reacting with the curable precursor) may be used as the above-mentioned polymer (or thermoplastic resin). Such a polymer may have the functional group in a main chain thereof or in a side chain thereof. The functional group may be introduced into a main chain of the polymer with co-polymerization, co-condensation or the like and is usually introduced into a side chain of the polymer. Such a functional group may include a condensable or reactive functional group (for example, a hydroxyl group, an acid anhydride group, a carboxyl group, an amino or an imino group, an epoxy group, a glycidyl group, and an isocyanate group), a polymerizable functional group [for example, a C₂₋₆alkenyl group such as vinyl, propenyl, isopropenyl, butenyl, or allyl, a C₂₋₆alkynyl group such as ethynyl, propynyl, or butynyl, a C₂₋₆alkenylidene group such as vinylidene, or a functional group having the polymerizable functional group(s) (e.g., (meth)acryloyl group)], and others. Among these functional groups, the polymerizable functional group is preferred.

The thermoplastic resin having a polymerizable group in a side chain thereof, for example, may be produced by allowing (i) a thermoplastic resin having a reactive group (e.g., a group similar to the functional group exemplified in the paragraph of the condensable or reactive functional group) to react with (ii) a compound (polymerizable compound) having a group (reactive group) reactive with the reactive group of the thermoplastic resin and a polymerizable functional group to introduce the polymerizable functional group of the compound (ii) into the thermoplastic resin.

Examples of the thermoplastic resin (i) having the reactive group may include a thermoplastic resin having a carboxyl group or an acid anhydride group thereof [for example, a (meth)acrylic resin (e.g., a (meth)acrylic acid-(meth)acrylate copolymer such as a methyl methacrylate-(meth)acrylic acid copolymer, and a methyl methacrylate-acrylate-(meth)acrylic acid copolymer), a polyester-series resin or polyamide-series resin having a terminal carboxyl group], a thermoplastic resin having a hydroxyl group [for example, a (meth)acrylic resin (e.g., a (meth)acrylate-hydroxyalkyl(meth)acrylate copolymer), a polyester-series resin or a polyurethane-series resin having a terminal hydroxyl group, a cellulose derivative (e.g., a hydroxyC₂₋₄alkyl cellulose such as a hydroxyethyl cellulose or a hydroxypropyl cellulose), a polyamide-series resin (e.g., an N-methylolacrylamide copolymer)], a thermoplastic resin having an amino group (e.g., a polyamide-series resin having a terminal amino group), and a thermoplastic resin having an epoxy group [e.g., a (meth)acrylic resin or polyester-series resin having an epoxy group (such as a glycidyl group)]. Moreover, there may be used a resin obtained by introducing the reactive group into a thermoplastic resin (such as a styrenic resin or an olefinic resin, and an alicyclic olefinic resin) with co-polymerization or graft polymerization as the thermoplastic resin (i) having the reactive group. Among these thermoplastic resins (i), a thermoplastic resin having a carboxyl group or an acid anhydride group thereof, a hydroxyl group or a glycidyl group (particularly a carboxyl group or an acid anhydride group thereof) as a reactive group, is preferred. Incidentally, among the (meth)acrylic resins, the copolymer preferably contains (meth)acrylic acid in a proportion of not less than 50 mol %. These thermoplastic resins (i) may be used singly or in combination.

The reactive group of the polymerizable compound (ii) may include a group reactive with the reactive group of the thermoplastic resin (i), for example, a functional group similar to the condensable or reactive functional group exemplified in the paragraph of the functional group of the polymer mentioned above.

Examples of the polymerizable compound (ii) may include a polymerizable compound having an epoxy group [e.g., an epoxy group-containing (meth)acrylate (an epoxyC₃₋₈alkyl(meth)acrylate such as glycidyl (meth)acrylate or 1,2-epoxybutyl(meth)acrylate; an epoxycycloC₅₋₈alkenyl(meth)acrylate such as epoxycyclohexenyl(meth)acrylate), and allyl glycidyl ether], a compound having a hydroxyl group [for example, a hydroxyl group-containing (meth)acrylate, e.g., a hydroxyC₂₋₄alkyl(meth)acrylate such as hydroxypropyl (meth)acrylate; a C₂₋₆alkylene glycol mono(meth)acrylate such as ethylene glycol mono(meth)acrylate], a polymerizable compound having an amino group [e.g., an amino group-containing (meth)acrylate; a C₃₋₆alkenylamine such as allylamine; an aminostyrene such as 4-aminostyrene or diaminostyrene], a polymerizable compound having an isocyanate group [e.g., a (poly)urethane (meth)acrylate, or vinylisocyanate], and a polymerizable compound having a carboxyl group or an acid anhydride group thereof [e.g., an unsaturated carboxylic acid or an anhydride thereof, such as (meth)acrylic acid or maleic anhydride]. These polymerizable compounds (ii) may be used singly or in combination.

Incidentally, the combination of the reactive group of the thermoplastic resin (i) with the reactive group of the polymerizable compound (ii) may include, for example, the following combinations.

(i-1) the reactive group of the thermoplastic resin (i): carboxyl group or acid anhydride group thereof,

the reactive group of the polymerizable compound (ii): epoxy group, hydroxyl group, amino group, isocyanate group;

(i-2) the reactive group of the thermoplastic resin (i): hydroxyl group,

the reactive group of the polymerizable compound (ii): carboxyl group or acid anhydride group thereof, isocyanate group;

(i-3) the reactive group of the thermoplastic resin (i): amino group,

the reactive group of the polymerizable compound (ii): carboxyl group or acid anhydride group thereof, epoxy group, isocyanate group; and

(i-4) the reactive group of the thermoplastic resin (i): epoxy group,

the reactive group of the polymerizable compound (ii): carboxyl group or acid anhydride group thereof, amino group

Among the polymerizable compounds (ii), an epoxy group-containing polymerizable compound (such as an epoxy group-containing (meth)acrylate is particularly preferred.

The functional group-containing polymer, e.g., a polymer in which a polymerizable unsaturated group is introduced into one or some of carboxyl groups in a (meth)acrylic resin, is available, for example, as “CYCLOMER-P” from Daicel Chemical Industries, Ltd. Incidentally, “CYCLOMER-P” is a (meth)acrylic polymer in which epoxy group(s) of 3,4-epoxycyclohexenylmethyl acrylate is allowed to react with one or some of carboxyl groups in a (meth)acrylic acid-(meth)acrylate copolymer for introducing photo-polymerizable unsaturated group(s) into the side chain of the polymer.

The amount of the functional group (particularly the polymerizable group) that participates in (or being involved in) a curing reaction and is introduced into the thermoplastic resin, is about 0.001 to 10 mol, preferably about 0.01 to 5 mol and more preferably about 0.02 to 3 mol relative to 1 kg of the thermoplastic resin.

The glass transition temperature of the thermoplastic resin (polymer) may be selected within the range of, for example, about −100° C. to 250° C., preferably about −50° C. to 230° C., and more preferably about 0° C. to 200° C. (for example, about 50° C. to 180° C.).

Considering the surface hardness, it is advantageous that the glass transition temperature of the thermoplastic resin (polymer) is not lower than 50° C. (e.g., about 70° C. to 200° C.) and preferably not lower than 100° C. (e.g., about 100° C. to 170° C.). The weight-average molecular weight of the polymer may be selected from the range of, for example, not more than 1,000,000, and preferably about 1,000 to 500,000.

As described above, the resin component comprises a plurality of resins which phase-separate from each other. The plurality of resin components (the plurality of polymers) may phase-separate from each other (in the absence of a solvent), or may phase-separate from each other in a liquid phase before completion of evaporation of a solvent. Moreover, the plurality of polymers may be incompatible with each other.

Incidentally, the resin component may further contain a resin component which does not phase-separate from at least one of the plurality of resin components (thermoplastic resins). For example, the resin component may comprise two resin components does not phase-separate from each other and a resin component which does not phase-separate from (or which is compatible with) any one of these components.

In the resin component, the combination of the resin is not particularly limited to a specific one as long as the resins used in a combination phase-separate from each other. A plurality of polymers incompatible with each other in the neighborhood of a processing temperature, for example, two polymers arbitrarily selected from the polymers mentioned above may be used in a combination. The difference in refractive index between the plurality of polymers (a first polymer and a second polymer) may be about 0 to 0.06, for example, about 0 to 0.04 (e.g., about 0.0001 to 0.04), and preferably about 0.001 to 0.03. Too large difference in refractive index between these polymers causes a large difference in refractive index between phase-separated domains formed within the functional layer. As a result, the functional layer easily generates an internal haze, and the advantages of the present invention are reduced.

The plurality of resins (or the resin component) may comprise at least a cellulose derivative, particularly, a cellulose ester (for example, a cellulose C₂₋₄aliphatic carboxylic acid ester such as a cellulose diacetate, a cellulose triacetate, a cellulose acetate propionate, or a cellulose acetate butyrate). For example, when the first polymer is a cellulose derivative (e.g., a cellulose ester such as a cellulose acetate propionate), the second polymer is preferably a(meth)acrylic resin, an alicyclic olefinic resin (e.g., a polymer obtained by using norbornene as a monomer), or a polyester-series resin (e.g., the above-mentioned polyC₂₋₄alkylene arylate-series copolyester). In particular, among these resins, the preferred resin includes a polymer having neither of aromatic ring nor halogen atom.

Moreover, in order to improve abrasion resistance after curing, it is preferable that at least one polymer (e.g., one of polymers incompatible with each other) in the plurality of resins contained in the resin component have a functional group (particularly, in a side chain thereof) that is reactive with the curable resin.

The ratio (weight ratio) of the first polymer relative to the second polymer [the former/the latter] may be selected from the range of, for example, about 1/99 to 99/1, preferably about 5/95 to 95/5 and more preferably about 10/90 to 90/10, and is usually about 20/80 to 80/20, particularly about 30/70 to 70/30. In particular, in the use of a cellulose derivative as the first polymer, the ratio (weight ratio) of the first polymer relative to the second polymer [the former/the latter] may be, for example, about 1/99 to 35/65, preferably about 3/97 to 30/70, and more preferably about 5/95 to 25/75 (e.g., about 6/94 to 20/80) particularly, about 7/93 to 18/82 (e.g., about 8/92 to 15/85).

In particular, in the resin component containing the cellulose derivative, the proportion of cellulose derivative relative to the whole resin component (the whole thermoplastic resin component) may be, for example, about 0.5 to 30% by weight, preferably about 1 to 25% by weight, more preferably about 2 to 20% by weight (e.g., about 3 to 15% by weight), and particularly about 5 to 12% by weight.

(Curable Resin)

As mentioned above, in order to impart abrasion resistance (hardcoat property) to the anti-glare layer or improve the abrasion resistance (hardcoat property) of the anti-glare layer, the anti-glare layer is usually a cured layer obtained by curing a coated layer further containing a curable resin (or curable resins). Specifically, the obtained anti-glare layer comprises the resin cured with an actinic ray (e.g., an ultraviolet ray, and an electron beam), heat, or means. Accordingly, such a cured resin can impart the abrasion resistance (hardcoat property) to the functional film and can improve durability of the functional film. Moreover, since the curable resin is contained in the coated layer, the uneven surface shape (or structure) of the anti-glare layer is efficiently formed by curing the coated layer.

The curable resin (or curable resin precursor) to be used may include various curable compounds having a reactive functional group to heat or an actinic ray (e.g., an ultraviolet ray, and an electron beam) and being capable of forming a resin (particularly a cured or a crosslinked resin) by curing or crosslinking with heat or an actinic ray.

The curable resin (or precursor) may include, for example, a thermosetting compound or resin [a low molecular weight compound (or prepolymer such as a low molecular weight resin (e.g., an epoxy-series resin, an unsaturated polyester-series resin, a urethane-series resin, and a silicone-series resin)) having an epoxy group, an isocyanate group, an alkoxysilyl group, a silanol group, a polymerizable group (such as vinyl group, allyl group, or (meth)acryloyl group), or others], and a photo-curable compound that is curable with an actinic ray (such as ultraviolet ray) (e.g., an ultraviolet-curable compound such as a photo-curable monomer, oligomer, or prepolymer). The photo-curable compound may be an EB (electron beam)-curable compound, or others. Incidentally, a photo-curable compound such as a photo-curable monomer, a photo-curable oligomer, or a photo-curable resin which may have a low molecular weight is sometimes simply referred to as “photo-curable resin”. These curable resin precursors may be used singly or in combination.

The photo-curable compound usually has a photo-curable group, for example, a polymerizable group (e.g., vinyl group, allyl group, (meth)acryloyl group) or a photosensitive group (e.g., cinnamoyl group). In particular, the preferred compound includes a photo-curable compound having a polymerizable group [e.g., a monomer, an oligomer (or resin, particularly a low molecular weight resin)]. These photo-curable compounds may be used singly or in combination.

Among the photo-curable compounds having a polymerizable group, the monomer may include, for example, a monofunctional monomer [for example, a (meth)acrylic monomer such as a (meth)acrylic ester, e.g., an alkyl (meth)acrylate (e.g., a C₁₋₂₄alkyl(meth)acrylate such as methyl(meth)acrylate, ethyl(meth)acrylate, butyl (meth)acrylate, isobutyl(meth)acrylate, 2-ethylhexyl (meth)acrylate, isodecyl(meth)acrylate, n-lauryl (meth)acrylate, or n-stearyl(meth)acrylate), a cycloalkyl (meth)acrylate, a (meth)acrylate having a crosslinked cyclic hydrocarbon group (e.g., isobornyl(meth)acrylate and adamantyl(meth)acrylate), glycidyl(meth)acrylate; a fluorine-containing alkyl(meth)acrylate such as perfluorooctylethyl(meth)acrylate or trifluoroethyl (meth)acrylate; a vinyl-series monomer such as a vinyl ester (e.g., vinyl acetate) or vinylpyrrolidone], a polyfunctional monomer having at least two polymerizable unsaturated bonds [for example, an alkylene glycol di(meth)acrylate such as ethylene glycol di(meth)acrylate, propylene glycol di(meth)acrylate, butanediol di(meth)acrylate, neopentyl glycol di(meth)acrylate, or hexanediol di(meth)acrylate; a (poly)alkylene glycol di(meth)acrylate such as diethylene glycol di(meth)acrylate, dipropylene glycol di(meth)acrylate, or a polyoxytetramethylene glycol di(meth)acrylate; a di(meth)acrylate having a crosslinked cyclic hydrocarbon group (e.g., tricyclodecane dimethanol di(meth)acrylate and adamantane di(meth)acrylate); and a polyfunctional monomer having about 3 to 6 polymerizable unsaturated bonds (e.g., trimethylolpropane tri(meth)acrylate, trimethylolethane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, and dipentaerythritol hexa(meth)acrylate)].

Among the photo-curable compounds having a polymerizable group, examples of the oligomer or resin may include a (meth)acrylate of a bisphenol A added with an alkylene oxide, an epoxy(meth)acrylate (e.g., a bisphenol A-based epoxy(meth)acrylate, and a novolak-based epoxy (meth)acrylate), a polyester (meth)acrylate (e.g., an aliphatic polyester-based (meth)acrylate and an aromatic polyester-based (meth)acrylate), a (poly)urethane (meth)acrylate (e.g., a polyester-based urethane (meth)acrylate and a polyether-based urethane (meth)acrylate), a silicone (meth)acrylate, and others. A hybrid photo-curable compound manufactured by JSR Corporation has been put on the market under the trade name “OPSTAR”.

The preferred curable resin precursor includes a photo-curable compound curable in a short time, for example, an ultraviolet-curable compound (e.g., a monomer, an oligomer, and a resin which may have a low molecular weight) and an EB-curable compound. In particular, a resin precursor having a practical advantage is an ultraviolet-curable monomer or an ultraviolet-curable resin. Further, in order to improve resistance such as abrasion resistance, the photo-curable resin is preferably a compound having not less than 2 (preferably about 2 to 6, and more preferably about 2 to 4) polymerizable unsaturated bonds in the molecule.

The molecular weight of the curable resin is, allowing for compatibility to the polymer, not more than about 5000 (e.g., about 100 to 5000), preferably not more than about 2000 (e.g., about 150 to 2000), and more preferably not more than about 1000 (e.g., about 200 to 1000).

The curable resin may be used in combination with a curing agent depending on the variety of the resin. For example, a thermosetting resin may be used in combination with a curing agent such as an amine or a polyfunctional carboxylic acid (or a polycarboxylic acid), or a photo-curable resin may be used in combination with a photopolymerization initiator.

The photopolymerization initiator may include a conventional component, e.g., an acetophenone, a propiophenone, a benzyl, a benzoin, a benzophenone, a thioxanthone, an acylphosphine oxide, and others.

The content of the curing agent (such as a photo-curing agent) relative to 100 parts by weight of the curable resin is about 0.1 to 20 parts by weight, preferably about 0.5 to 10 parts by weight, and more preferably about 1 to 8 parts by weight (particularly about 1 to 5 parts by weight) and may be about 3 to 8 parts by weight.

Further, the curable resin precursor may contain a curing accelerator, a crosslinking agent, a thermal-polymerization inhibitor, and others. For example, the photo-curable resin precursor may be used in combination with a photo-curing accelerator, e.g., a tertiary amine (e.g., a dialkylaminobenzoic ester) or a phosphine-series photopolymerization accelerator.

In the present invention, the resin component comprises a plurality of resins which phase-separate from each other(resin component), as described above. The resin component (thermoplastic resin component) may or may not have phase-separability from (or incompatibility with) the curable resin (particularly, a monomer or oligomer having a plurality of curable functional groups). Moreover, a curable resin precursor which is compatible with at least one of the polymers (resins) around a processing temperature is practically used. For example, in a combination use of the curable resin and the plurality of polymers incompatible with each other containing a first polymer and a second polymer, the curable resin is not particularly limited to a specific one as long as the curable resin is compatible with at least one of the first and second polymers. The curable resin may be compatible with both polymers. A resin component containing a curable resin compatible with both polymer components may phase-separate into two phases, where one is a phase of a mixture containing the first polymer and the curable resin as main components, and another is a phase of a mixture containing the second polymer and the curable resin as main components.

When both components to be phase-separated are highly compatible with each other, both components fail to generate phase separation effectively during a drying step for evaporating the solvent, and the obtained layer has lower functions for an anti-glare layer.

Incidentally, each of the phase separability of the plurality of polymers and the phase separability of the plurality of polymers and the curable monomer can be judged conveniently by preparing a uniform solution with a good solvent to both components and visually conforming whether the residual solid content becomes clouded or not during a step for evaporating the solvent gradually.

Further, the plurality of polymers and a cured or crosslinked resin obtained by curing the curable resin are usually different from each other in refractive index. Moreover, the plurality of polymers (for example, a first polymer and a second polymer) are also different from each other in refractive index. In the present invention, the difference in refractive index between the plurality of the polymers (or resin component) and the cured or crosslinked resin, or the difference in refractive index between the plurality of polymers (the first polymer and the second polymer) may be, for example, about 0 to 0.06, preferably about 0.0001 to 0.05, and more preferably about 0.001 to 0.04. The selection of the polymers having such a difference in refractive index can produce phase-separated domains having such a difference in refractive index.

The proportion (weight ratio) of the resin component (or the plurality of resins) relative to the curable resin is not particularly limited to a specific one, and for example, the resin component/the curable resin may be selected within the range of about 5/95 to 95/5. In order to enhance the surface hardness, the proportion (weight ratio) is preferably about 5/95 to 80/20, more preferably about 10/90 to 70/30, and particularly about 15/85 to 60/40. In particular, in the resin component containing the cellulose derivative in whole or in part thereof, the proportion (weight ratio) of the resin component relative to the curable resin may be about 10/90 to 80/20, preferably about 20/80 to 70/30, and more preferably about 30/70 to 60/40 (e.g., about 35/65 to 55/45).

The surface (a side which is not in contact with the substrate) of the anti-glare layer may usually have an uneven structure. Such an uneven surface structure is usually formed by the phase separation of at least the plurality of resins (or resin component). In particular, the uneven surface structure may be an uneven structure formed by the phase separation and convection phenomenon (convection phenomenon in the coating surface) of the plurality of resins.

That is, with the progress of the phase separation, the bicontinuous structure is formed. On further proceeding the phase separation, the continuous phase becomes discontinuous owing to its own surface tension to change into the droplet phase structure (e.g., an islands-in-the-sea structure containing independent phases such as ball-like shape, spherical shape, discotic shape, oval-sphere shape or rectangular prism shape). Therefore, an intermediate structure of the bicontinuous phase structure and the drop phase structure (i.e., a phase structure in a transitional state from the bicontinuous phase to the drop phase) can also be formed by varying the degree of phase separation. The phase-separation structure in the anti-glare layer in the present invention may be an islands-in-the-sea structure (a droplet phase structure, or a phase structure in which one phase is independent or isolated) or a bicontinuous phase structure (or a mesh structure), or may be an intermediate structure being a coexistent state of a bicontinuous phase structure and a droplet phase structure. The phase-separation structure (domain) can be observed by an examination of the cross section of the film under a transmission electron microscope.

Thus a difference in refractive index between materials (the resin component and the cured product of the curable resin precursor) constituting the anti-glare layer having an uneven surface due to a phase separation can be adjusted within the above-mentioned range. Accordingly, the anti-glare layer substantially contains no scattering medium that causes scattering in the interior of the layer, unlike an anti-glare layer obtained by a method that comprises dispersing a fine particle to form an uneven surface. Therefore, the haze in the interior of the layer (the internal haze causing scattering in the interior of the layer) is low, for example, may be about 0 to 1%, preferably about 0 to 0.8% (e.g., about 0.01 to 0.8%), and more preferably about 0 to 0.5% (e.g., 0.1 to 0.5%). Incidentally, the internal haze can be determined by pasting a smooth transparent film on the uneven surface of the anti-glare layer through a transparent adhesive layer and measuring a haze of the planarized matter.

The thickness (mean thickness) of the anti-glare layer may be, for example, about 0.3 to 20 μm, preferably about 1 to 18 μm (e.g., about 3 to 16 μm), and usually about 5 to 15 μm (particularly about 7 to 13 μm).

Incidentally, the anti-glare layer may be surface-treated. Such a surface treatment enhances the affinity of the anti-glare layer surface for the high-refractive-index particle, whereby the localization of the high-refractive-index particle in the anti-reflection layer is sometimes prompted.

[Anti-Reflection Layer]

The anti-reflection layer (or the anti-reflection film) comprises the low-refractive-index particle and the high-refractive-index particle. Such an anti-reflection layer usually comprises the low-refractive-index particle, the high-refractive-index particle, and the low-refractive-index resin (specifically, the low-refractive-index resin as a resin component or a film-forming resin). Incidentally, in the case where the low-refractive-index resin is a curable resin, the anti-reflection layer usually comprises a cured product of the curable resin. Moreover, the functional film of the present invention has the anti-reflection layer in which the low-refractive-index particle is usually localized near a first surface (a surface which does not contact with the anti-glare layer) of the anti-reflection layer. In particular, in addition to the localization of the low-refractive-index particle, in the anti-reflection layer, the high-refractive-index particle is localized near a second surface of the anti-reflection layer or the anti-glare layer (particularly, along the form of the uneven surface structure of the anti-glare layer). Such a functional film can achieve a high anti-glare property and anti-reflection property simultaneously. When the functional film is attached to a display apparatus such as a liquid crystal display apparatus so as to allow the anti-reflection layer to be the outermost surface, the functional film provides an excellent anti-glare property and effectively prevents a light coming from a light source around the display apparatus (e.g., an ambient light) from reflecting on the surface of the functional film. Incidentally, a conventional anti-reflection layer comprises a high-refractive-index layer which comprises a high-refractive-index particle and a resin and a low-refractive-index layer which comprises a low-refractive-index particle and a resin and is laminated on the high-refractive-index layer. The conventional anti-reflection layer is obtained by forming the layers in two steps, whereby it is impossible to form a uniform multi-layer structure. Therefore, the conventional anti-reflection layer has a shortcoming as follows: the conventional anti-reflection layer attached to a display apparatus increases the reflectance, whereby light-room contrast of an image on the display is decreased.

(Low-Refractive-Index Resin)

The refractive index (n) of the low-refractive-index resin may for example be about 1.4 to 1.55, preferably about 1.41 to 1.54, and more preferably about 1.42 to 1.53.

The low-refractive-index resin to be used is not particularly limited to a specific one as long as the refractive index is within the range mentioned above. The low-refractive-index resin to be used may include a conventional resin. In the present invention, a curable resin (a heat- or photo-curable resin) is preferably used as the low-refractive-index resin. In particular, a (meth)acrylic resin (a heat- or photo-curable (meth)acrylic resin) and/or a silicone-series resin are preferable.

The acrylic resin may include, for example, a polyfunctional (meth)acrylate [for example, a difunctional (meth)acrylate such as 1,6-hexanediol di(meth)acrylate; a polyhydroxyalkane poly(meth)acrylate (e.g., a tri- to hexahydroxyalkane tri- to hexa(meth)acrylate such as pentaerythritol tri- or tetra(meth)acrylate, trimethylolpropane tri(meth)acrylate, or trimethylolethane tri(meth)acrylate, preferably a tri- to hexahydroxyC₃₋₁₀alkane tri- to hexa(meth)acrylate, more preferably a tri- to hexahydroxyC₃₋₁₀alkane tri- to hexa(meth)acrylate; and tri- or more functional (polyfunctional) (meth)acrylate (e.g., a poly(tri- to hexahydroxyalkane) tri- to hexa(meth)acrylate such as ditrimethylolpropane tetra(meth)acrylate or dipentaerythritol penta- or hexa(meth)acrylate, preferably, di(tri- to hexahydroxyC₃₋₁₀alkane) tri- to hexa(meth)acrylate, more preferably, di(tri- to hexahydroxyC₃₋₁₀alkane) tri- to hexa(meth)acrylate)], a heat- or photo-curable acrylic resin such as a (poly)urethane (meth)acrylate; a homo- or copolymer of a (meth)acrylicmonomer {for example, a (meth)acrylate [e.g., a C₁₋₂₄alkyl(meth)acrylate such as methyl(meth)acrylate, ethyl(meth)acrylate, butyl(meth)acrylate, 2-ethylhexyl (meth)acrylate, n-lauryl(meth)acrylate, or n-stearyl (meth)acrylate], and a fluorine-containing alkyl (meth)acrylate [e.g., perfluorooctylethyl(meth)acrylate and trifluoroethyl(meth)acrylate]}, and a copolymer of a (meth)acrylic monomer and other copolymerizable monomer. These acrylic resins may be used alone or in combination.

The silicone-series resin may include, for example, a resin obtained by a simultaneous radical polymerization or hydrolytic condensation of the acrylic resin (or (meth)acrylic monomer) and an organic silicon compound (silane coupling agent) or a mixture of a radical-polymerization or hydrolytic condensation product of the acrylic resin (or (meth)acrylic monomer) and a radical-polymerization or hydrolytic condensation product of an organic silicon compound (silane coupling agent). The organic silicon compound may include, for example, the silane coupling agent mentioned later, for example, an epoxy group-containing silane coupling agent [e.g., a glycidyloxyC₁₋₄alkyltriC₁₋₄alkoxysilane such as glycidyloxymethyltrimethoxysilane, glycidyloxymethyltriethoxysilane, 2-glycidyloxyethyltrimethoxysilane, 2-glycidyloxyethyltriethoxysilane, 3-glycidyloxypropyltrimethoxysilane, or 3-glycidyloxypropyltriethoxysilane; and 3-(2-glycidyloxyethoxy)propyltrimethoxysilane] and an ethylenic unsaturated bond group-containing silane coupling agent [e.g., a vinyltriC₁₋₄alkoxysilane such as vinyltrimethoxysilane; a (meth)acryloyloxyC₁₋₄alkylC₁₋₄alkoxysilane such as (meth)acryloxymethyltrimethoxysilane, (meth)acryloxymethyltriethoxysilane, 2-(meth)acryloxyethyltrimethoxysilane, 2-(meth)acryloxyethyltriethoxysilane, 3-(meth)acryloxypropyltrimethoxysilane, or 3-(meth)acryloxypropyltriethoxysilane]. The proportion (weight ratio) of the acrylic monomer relative to the silane coupling agent [the former/the latter] is, for example, about 99/1 to 10/90, preferably about 97/3 to 30/70, more preferably about 95/5 to 50/50. Moreover, the silicone-series resin may be, for example, a methyl-series silicone resin, a methylphenyl-series silicone resin, an acryl-modified silicone resin, and an epoxy-modified silicone resin. These silicone-series resins may be used alone or in combination.

Among these low-refractive-index resins, a curable resin having a (meth)acryloyl group (for example, a tri- or more functional (polyfunctional) (meth)acrylate) is preferred. Since such a resin has a large number of reactive functional groups (bonding sites), the low-refractive-index resins in the component are strongly combined with each other or with the low-refractive-index particle (such as a surface-treated hollow silica particle). Therefore, a transparent coated layer having an excellent strength and abrasion resistance can be formed.

Furthermore, the low-refractive-index resin may be used in combination with a reactive resin having two or less functional (reactive) group(s) introduced (added) thereto as a water repellent agent. Such a reactive resin may include, for example, a hydrophobic resin having a (meth)acryloyl group [e.g., a silicone-series resin having a (meth)acryloyl group, a fluorine-series resin having a (meth)acryloyl group, and an olefinic resin having a (meth)acryloyl group] and a siloxane-series acrylic resin (e.g., a resin comprising a polysiloxane and an acrylic resin (such as a urethane (meth)acrylate) is bonded to an end of a polysiloxane). The hydrophobic resin having a (meth)acryloyl group may be, for example, a hydrophobic resin in which a (meth)acryloyl group is bonded to an end of a polysiloxane resin or fluorine resin. These water repellent agents may be used alone or in combination.

Owing to a low compatibility of such a reactive resin with the low-refractive-index resin, when the reactive resin is used in combination with the low refractive-index resin, the reactive resin forms a surface layer of the anti-reflection layer, which is a transparent coated layer. Therefore, water repellency (i.e., the contact angle of not less than 90° against water) is imparted to the surface of the transparent coated layer. This prevents adhesion of a stain or smudge such as a fingerprint, a sebum or sebaceous matter, or a sweat on the transparent coated layer. Even if a stain or smudge is adhered on the transparent coated layer, the stain or smudge is easily wiped away therefrom.

The proportion of the water repellent agent relative to the low-refractive-index resin, which is a matrix, is, for example, about 0.1 to 10% by weight, and preferably about 0.5 to 5% by weight, in terms of solid contents. An excessively small amount of the water repellent agent fails to improve stain resistance (such as fingerprint resistance or marking-pen repellency) in addition to water repellency. On the other hand, an excessively large amount of the water repellent agent results in that the water repellent agent appears on the surface of the coated layer (bleed out). Therefore, an abnormal appearance of the coated layer (such as unevenness or whitening or blooming) is produced and the hardness of the coated layer tends to be reduced.

The low-refractive-index resin for the anti-reflection layer may also be used in combination with a curing agent or a crosslinking agent, a polymerization initiator, a hardening accelerator, which are exemplified in the paragraph describing the curable precursor for the anti-glare layer. In particular, the low-refractive-index resin is preferably used in combination with an acetophenone-series, benzoinether-series, or a thioxanthone-series photopolymerization initiator. The proportion of the polymerization initiator such as a photopolymerization initiator relative to 100 parts by weight of the low-refractive-index resin is about 0.1 to 15 parts by weight, preferably about 0.5 to 10 parts by weight, and more preferably about 1 to 8 parts by weight. An excessively small amount of the polymerization initiator sometimes fails to allow the polymerization of the resin component applied on the anti-glare layer to proceed even with an aid of an irradiation with an actinic ray (e.g., an ultraviolet ray). An excessively large amount of the polymerization initiator easily causes a polymerization of the resin component even in its use. Therefore, when a coated layer having such an amount of the polymerization initiator is applied on the anti-glare layer, the obtained coated layer becomes whitish.

(Low-Refractive-Index Particle)

Representative examples of the low-refractive-index particle include a hollow particle. Incidentally, in this description, the hollow particle means a particle having a cavity therein.

Such a hollow particle may include, for example, a metal oxide (or an inorganic oxide) particle, particularly, a silica particle (a hollow silica particle), and the like.

The entire shape of the low-refractive-index particle (particularly, the hollow silica particle) is not particularly limited to a specific one. For example, the shape may include a spherical shape, an ellipsoidal shape, and an amorphous shape. Among these shapes, the hollow particle may usually have a spherical shape.

The shape and size of the cavity in the hollow particle are not particularly limited to specific ones as long as the refractive index of the particle is within the after-mentioned range.

The hollow particle may usually comprise one cavity as a core and an outer shell (or a shell) thereof. In the case of a spherical particle, the particle may have one spherical cavity. The hollow particle may have a plurality of cavities (e.g., cavities having a spherical shape or an ellipsoidal shape) therein. Among such hollow particles, a hollow silica particle is described in Japanese Patent Application Laid-Open Nos. 233611/2001 (JP-2001-233611A), 192994/2003 (JP-2003-192994A), and others. The hollow silica particles as described in these documents are a colloidal particle having a low refractive index, and have an excellent dispersibility. In the present invention, the hollow silica particle as described in these documents may be preferably used, and the particles may be produced by production processes as described in these documents.

The mean particle diameter of the low-refractive-index particle [e.g., a hollow particle (particularly, a hollow silica particle)] may be selected from the range of not more than 100 nm (e.g., about 30 nm to 90 nm) and may be about 40 to 80 nm, preferably about 50 to 70 nm, and more preferably about 55 to 65 nm. A low-refractive-index particle (such as a hollow particle) having an extremely small mean particle diameter has a larger refractive index, thereby increasing the refractive index of the anti-reflection layer. Therefore, the anti-reflection layer provides a poor light-room contrast, which often allows a screen image to be whitish. On the other hand, the larger mean particle diameter the low-refractive-index particle has, the smaller the difference between the mean particle diameters and the film thickness becomes. Therefore, a low-refractive-index particle having an extremely large mean particle diameter sometimes produces an undesirable uneven surface structure of the anti-reflection-layer. Such a surface structure sometimes causes undesired light scattering.

The refractive index (n) of the low-refractive-index particle [e.g., a hollow particle (particularly, a hollow silica particle)] may be, for example, about 1.2 to 1.25, and preferably about 1.21 to 1.24. An excessively low refractive index of the particle deteriorates efficient production of the functional film. A low-refractive-index particle having an extremely high refractive index results in an anti-reflection layer having a high refractive index. Such an anti-reflection layer provides a poor light-room contrast, which often allows a screen image to be whitish.

The low-refractive-index particle (e.g., a hollow particle) may usually be a surface-treated particle [for example, a surface-treated hollow particle (a hollow particle surface-treated with a surface-treating agent]. The surface-treating agent may include, for example, a coupling agent such as a silane coupling agent.

Examples of the silane coupling agent may include an alkoxysilyl group-containing silane coupling agent [for example, a tetraalkoxysilane (e.g., a tetraC₁₋₄alkoxysilane such as tetramethoxysilane or tetraethoxysilane, and tetraphenoxysilane) and a trialkoxysilane (e.g., a C₁₋₁₂alkyltriC₁₋₄alkoxysilane such as methyltrimethoxysilane or octyltriethoxysilane, a diC₂₋₄alkyldiC₁₋₄alkoxysilane such as dimethyldimethoxysilane, and an arylC₁₋₄alkoxysilane such as phenyltrimethoxysilane or diphenyldimethoxysilane)], a halogen-containing silane coupling agent [e.g., a trifluoroC₂₋₄alkyldiC₁₋₄alkoxysilane such as trifluoropropyltrimethoxysilane, a perfluoroalkylC₂₋₄alkyldiC₁₋₄alkoxysilane such as perfluorooctylethyltrimethoxysilane, a chloroC₂₋₄alkyltriC₁₋₄alkoxysilane such as 2-chloroethyltrimethoxysilane, and a C₁₋₄alkyltrichlorosilane such as methyltrichlorosilane], a vinyl group-containing silane coupling agent (e.g., a vinyltriC₁₋₄alkoxysilane such as vinyltrimethoxysilane), an ethylenic unsaturated bond group-containing silane coupling agent [e.g., a (meth)acryloxyC₂₋₄alkylC₁₋₄alkoxysilane such as 2-(meth)acryloxyethyltrimethoxysilane or 3-(meth)acryloxypropylmethyldimethoxysilane], an epoxy group-containing silane coupling agent [e.g., a C₂₋₄alkyltriC₁₋₄alkoxysilane having an alicyclic epoxy group such as 2-(3,4-epoxycyclohexyl)ethyltrimethoxysilane, a glycidyloxyC₂₋₄alkyltriC₁₋₄alkoxysilane such as 2-glycidyloxyethyltrimethoxysilane, and 3-(2-glycidyloxyethoxy) propyltrimethoxysilane, an amino group-containing silane coupling agent [e.g., a aminoC₂₋₄alkylC₁₋₄alkoxysilane such as 2-aminoethyltrimethoxysilane or 3-aminopropylmethyldimethoxysilane, 3-[N-(2-aminoethyl)amino]propyltrimethoxysilane, N-phenyl-3-aminopropyltrimethoxysilane, and 3-ureidoisopropylpropyltriethoxysilane], a mercapto group-containing silane coupling agent (e.g., a mercaptoC₂₋₄alkyltriC₁₋₄alkoxysilane such as 3-mercaptopropyltrimethoxysilane), a carboxyl group-containing silane coupling agent (e.g., a carboxyC₂₋₄alkyltriC₁₋₄alkoxysilane such as 2-carboxyethyltrimethoxysilane), and a silanol group-containing silane coupling agent (e.g., trimethylsilanol). These silane coupling agents may be used singly or in combination.

Conventional methods (e.g., methods as described in the above-mentioned JP-2001-233611A or JP-2003-192994A) may be utilized as a surface-treatment method. The utilizable method may include a method that comprises adding a coupling agent such as a silane coupling agent to a dispersion of the hollow particle (e.g., the hollow silica particle) (e.g., an alcohol dispersion), and further adding water to the dispersion, and adding a hydrolysis catalyst such as an acid or an alkali thereto according to need.

(High-Refractive-Index Particle)

The high-refractive-index particle may include, for example, a metal oxide (or inorganic oxide) particle. The examples of the metal constituting the metal oxide may include a transition metal [e.g., a metal of the Group 4 of the Periodic Table of Elements (for example, titanium and zirconium) and a metal of the Group 12 of the Periodic Table of Elements (for example, zinc)], a representative (typical) metal [for example, a metal of the Group 13 of the Periodic Table of Elements (for example, aluminum and indium), a metal of the Group 14 of the Periodic Table of Elements (for example, tin), and a metal of the Group 15 of the Periodic Table of Elements (for example, antimony)]. The metal oxide may be a metal oxide containing one or more metal(s) mentioned above.

The representative high-refractive-index particle (metal oxide particle) may include, for example, a titanium-containing metal oxide [for example, a titanium oxide (such as TiO₂)] particle, a zirconium-containing metal oxide [for example, a zirconium oxide (such as ZrO₂)] particle, an aluminum-containing metal oxide [for example, an aluminum oxide (such as Al₂O₃)] particle, an indium-containing metal oxide [for example, an indium oxide (In₂O₃) and an indium tin oxide (ITO)] particle, a zinc-containing metal oxide [for example, a zinc oxide (such as ZnO)] particle, a tin-containing metal oxide [for example, a tin oxide (SnO₂) and an antimony-containing tin oxide (ATO)] particle, and an antimony-containing metal oxide [for example, antimony(V) oxide (Sb₂O₅)] particle. These particles may be used alone or in combination.

Among these particles, an antimony-containing tin oxide (ATO) particle or an antimony(V) oxide (Sb₂O₅) particle is preferable. In particular, an ATO particle is preferable. Such a particle has advantages as follows: the easiness of increasing in the refraction index of the particle; the easiness of the surface treatment; the ready availability; and the like.

The high-refractive-index particle may usually be a surface-treated particle. The surface-treatment agent may include, for example, the coupling agent exemplified in the paragraph concerning the low-refractive-index particle. The surface-treatment agents may be used alone or in combination.

Incidentally, conventional methods (e.g., methods as described in the above-mentioned JP-2001-233611A or JP-2003-192994A) may be utilized as a surface-treatment method. The utilizable method may include a method that comprises adding a coupling agent such as a silane coupling agent to a dispersion of the high-refractive-index particle (e.g., an alcohol dispersion), and further adding water to the dispersion, and adding a hydrolysis catalyst such as an acid or an alkali thereto according to need.

The mean particle diameter of the high-refractive-index particle may be, for example, 1 to 70 nm (for example, 2 to 60 nm), preferably 3 to 50 nm, and more preferably 4 to 40 nm (for example, 5 to 30 nm). A high-refractive-index particle having an excessively small mean particle diameter is difficult to obtain. Even if such a particle is obtained, the particle sometimes aggregates with each other owing to the poor dispersibility thereof. In addition, a high-refractive-index particle having an excessively large mean particle diameter sometimes increases the haze of the film.

The refractive index of the high-refractive-index particle may be, for example, in the range of about 1.6 to 1.8, preferably in the range of about 1.61 to 1.79, and more preferably in the range of about 1.62 to 1.78. Even if a high-refractive-index particle having an excessively low refractive index (for example, less than 1.60) is localized in a lower area of the anti-reflection film (a region near the anti-glare film), an enough anti-reflection performance is sometimes not achieved. Moreover, a high-refractive-index particle having an excessively high refractive index (for example, more than 1.80) increases the difference of the refractive index between an upper area (a region near the surface of the anti-reflection film) and a lower area of the anti-reflection film (a region near the anti-glare layer). Therefore, a reflectivity curve is sometimes unneutral. Incidentally, the refractive index of the high-refractive-index particle can be adjusted by the surface treatment or with the species of the surface-treatment agent used for a surface treatment.

In the anti-reflection layer, the proportion of the low-refractive-index particle relative to the high-refractive-index particle [the former/the latter (weight ratio)] may be, for example, about 99/1 to 30/70 (for example, about 95/5 to 40/60), preferably about 93/7 to 50/50, more preferably about 90/10 to 60/40 (for example, about 88/12 to 65/35), and particularly about 85/15 to 70/30.

Furthermore, in the case where the anti-reflection layer comprises the low-refractive-index resin, the proportion of the total amount of the low-refractive-index particle and the high-refractive-index particle relative to 1 part by weight of the low-refractive-index resin may be, for example, about 0.3 to 10 parts by weight, preferably about 0.5 to 5 parts by weight, and more preferably about 0.7 to 3 parts by weight (for example, about 1 to 2.5 parts by weight).

In particular, the proportion of the low-refractive-index particle (A), the low-refractive-index resin (B), and the high-refractive-index particle (C) [(A)/(B)/(C) (weight ratio)] may be, for example, about 30 to 69/1 to 30/1 to 69, preferably about 35 to 65/2 to 25/10 to 63, more preferably about 40 to 60/3 to 20/20 to 57 (particular about 45 to 50/4 to 10/40 to 51). The proportion of the three components in the range mentioned above provides anti-glareness and film-forming property in a well balanced way.

(Structure and Property of Functional Film)

The anti-glare layer of the functional film of the present invention usually has an uneven surface structure (uneven surface shape). The uneven surface structure is usually formed by phase separation of the plurality of resins (or resin component). Incidentally, the uneven structure may be formed by at least phase separation and convection phenomenon (convection phenomenon in a surface of the coated layer) of the plurality of resins. Specifically, the anti-glare layer comprises a matrix and a plurality of domains phase-separated from the matrix, and has an uneven surface formed by the domains and the matrix. The domains may be formed regularly or periodically.

That is, in the present invention, the plurality of domains of the surface of the anti-glare layer are formed at a relatively controlled interval corresponding to arrangement of phase-separation structure formed in a production process of the anti-glare layer. Moreover, almost all of the domains may be separated, or some adjacent domains may be connected with each other through a long and slender (or narrow) connection part. The shape of the domain is not particularly limited to a specific one and is an amorphous shape, a circular form, an oval (or elliptical) form, a polygonal form, and others. The shape is usually a circular form or an oval form.

Further, usually the domain (uneven surface) formed by phase separation substantially has regularity or periodicity. The mean distance between two adjacent projections of such an uneven surface [the pitch between the tops of two adjacent projections (or between the domains)] may be selected from the range of about 5 to 100 μm. For example, the mean distance is, for example, about 10 to 80 μm, and preferably about 20 to 50 μm. The mean distance between two adjacent projections is, for example, controllable by the thickness of the coated layer.

In the functional film of the present invention, as described above, the anti-reflection layer has the high-refractive-index particle localized near the second surface of the anti-reflection layer or the anti-glare layer (particularly, along the uneven surface structure of the anti-glare layer) and the low-refractive-index particle usually localized near the first surface of the anti-reflection layer. In particular, the anti-reflection layer may have a region containing the high-refractive-index particle localized near the anti-glare layer (a high-refractive-index region or a high-refractive-index particle-localized region) and a region containing the low-refractive-index particle localized near the first surface of the anti-reflection layer (a low-refractive-index region or a low-refractive-index particle-localized layer). Presumably, the lower the degree of hydrophobic property the low-refractive-index-particle surface is or the higher the degree of hydrophobic property the high-refractive-index particle-surface is, the more easily the anti-reflection layer having such two particle-localized regions is obtained. The anti-reflection layer having such a particle-localization form(s) thus has an anti-reflection property far better than a conventional anti-reflection layer. Incidentally, As long as the high-refractive-index region is a region comprising the high-refractive-index particle localized near the anti-glare layer, the region may further comprise other particles (a low-refractive-index particle). As long as the low-refractive-index region is a region comprising the low-refractive-index particle localized near the first surface of the anti-reflection layer, the region may further comprise other particles (a high-refractive-index particle).

In particular, the high-refractive-index region may comprise the low-refractive-index particle. In the anti-reflection layer of the functional film of the present invention, the region comprising the high-refractive-index particle and the region comprising the low-refractive-index particle may be distinctly separated from each other. In many cases, the concentration of the low-refractive-index particle is usually increased in a direction form the second surface to the first surface of the anti-reflection layer (and/or the concentration of the high-refractive-index particle is decreased in the same direction as mentioned above). In the case where the region comprising the high-refractive-index particle and the region comprising the low-refractive-index particle are not distinctly separated, in the description, the term “high-refractive-index region” means a region containing the high-refractive-index particles in a proportion (volume %) of 80, relative to all the high-refractive-index particles contained in the anti-reflection layer, measured from the second surface of the anti-reflection layer and the term “low-refractive-index region” means a region containing the low-refractive-index particles in a proportion (volume %) of 80, relative to all the low-refractive-index particles contained in the anti-reflection layer, measured from the second surface of the anti-reflection layer. Incidentally, the proportion of the high-refractive-index particle is defined from a photograph (e.g., a TEM photograph) of a cross-section of the functional film (or anti-reflection layer) or the like.

The thickness of the high-refractive-index region may be, for example, about 1 to 80 nm (e.g., about 2 to 60 nm), preferably about 3 to 50 nm (e.g., about 5 to 40 nm), and more preferably about 7 to 30 nm. The thickness of the low-refractive-index region may be, for example, about 30 to 200 nm (e.g., about 50 to 180 nm), preferably about 60 to 160 nm (e.g., about 70 to 150 nm), and more preferably about 90 to 120 nm.

Moreover, the proportion (thickness proportion) of the high-refractive-index region relative to the low-refractive-index region [the former/the latter] may be about 50/50 to 13/97, preferably about 40/60 to 5/95, more preferably about 30/70 to 10/90, and particularly about 25/75 to 15/85.

The refractive-index rate (n) of the low-refractive-index region may be selected from the range of about 1.3 to 1.4, for example, about 1.35 to 1.39, preferably about 1.36 to 1.38. In addition, the refractive index (n) of the high-refractive-index region may be selected from the range of about 1.5 to 1.8, for example, about 1.52 to 1.75, preferably about 1.55 to 1.70. A low-refractive-index region having an excessively low refractive index improves a light-room contrast. However, in this case, the proportion of the low-refractive-index particle needs to be increased, whereby the abrasion resistance of the film tends to be insufficient. A low-refractive-index region having an excessively high refractive index has a high reflectance, whereby the light-room contrast is decreased. In this case, the image on the display screen tends to be whitish. A high-refractive-index region having an excessively low refractive index causes a weak interference with a light reflected on the display surface, whereby the light-room contrast is decreased. A high-refractive-index region having an excessively high refractive index allows the entire film to appear colored and the light-room contrast to decrease.

The thickness of the anti-reflection layer may be, for example, about 90 to 240 nm, preferably about 100 to 230 nm (for example, about 120 to 220 nm), and more preferably about 150 to 210 nm. An excessively small thickness of the low-refractive-index region fails sometimes to comply with Fresnel principle. When such a layer is applied on an image on the display screen, a decrease in anti-reflection property and light-room contrast are caused, whereby the image on the display screen tends to be whitish. On the other hand, an excessively large thickness of the low-refractive-index region also fails sometimes to comply with Fresnel principle. When such a layer is applied on a display, a decrease in anti-reflection property and light-room contrast are caused, whereby the display tends to be whitish.

Since the functional film of the present invention has a structure formed in the above-mentioned manner, the functional film has an excellent anti-glareness and anti-reflection property (in addition, abrasion resistance). The surface roughness of the functional film may be represented by the average inclination angle of the surface of the functional film of the present invention. The above-mentioned average inclination angle may be within the range of about 0.5 to 1.5°, and may be, for example, about 0.7 to 1° and preferably about 0.8 to 0.95°. The average inclination angle may be measured in accordance with JIS (Japanese Industrial Standards) B0601 by using a contacting profiling surface texture and contour measuring instrument (manufactured by Tokyo Seimitsu Co., Ltd., the trade name “surfcom570A”).

Moreover, the total light transmittance of the functional film of the present invention is, for example, about 70 to 100%, preferably about 80 to 99%, and more preferably about 85 to 99% (particularly, about 88 to 98%).

The haze of the functional film of the present invention may be selected from the range of about 1 to 10%, and is, for example, about 2 to 6% and preferably about 3 to 5%.

Incidentally, the haze and the total light transmittance can be measured with a NDH-5000W haze meter manufactured by Nippon Denshoku Industries Co., Ltd. in accordance with JIS K7105.

The image clarity (transmitted image clarity) of the functional film of the present invention may be selected from the range of, in the case of using an optical slit of 0.5 mm width, about 60 to 80%, and is, for example, about 63 to 77% and preferably about 65 to 75%.

The image clarity is a measure for quantifying defocusing or distortion of a light transmitted through a film. The image clarity is obtained by measuring a light transmitted from a film through a movable optical slit, and calculating an amount of light in both a light part and a dark part of the optical slit. That is, in the case where a transmitted light is blurred by a film, the slit image formed on the optical slit becomes wider, and as a result the amount of light in the transmitting part is not more than 100%. On the other hand, in the non-transmitting part, the amount of light is not less than 0% due to leakage of light. The value C of the image clarity is defined by the following formula according to the maximum value M of the transmitted light in the transparent part of the optical slit, and the minimum value m of the transmitted light in the opaque part thereof.

C(%)=[(M−m)/(M+m)]×100

That is, the more the value C approaches 100%, the less the image is defocused by the anti-glare film [reference; Suga and Mitamura, Tosou Gijutsu, July, 1985].

There may be used an image clarity measuring apparatus (ICM-1DP, manufactured by Suga Test Instruments Co., Ltd.) as an apparatus for measuring the image clarity. There may be used an optical slit of 0.125 mm to 2 mm in width as the optical slit.

A film having an image clarity within the above-mentioned range is capable enough of blurring the outline (or contour) of an object reflected in the display. Such a film can excellently reduce glareness or dazzling. A film having an excessively high image clarity has a poor anti-reflection effect. On the other hand, a film having an excessively low image clarity inhibits the above-mentioned reflection but has a low image clearness (or sharpness).

The reflected light on the functional film of the present invention has a* of about 0.5 to 1.3 (preferably about 0.6 to 1.25, and more preferably about 0.7 to 1.2) and b* of about −2.3 to −0.5 (preferably about −2.3 to −0.6, and more preferably about −2.25 to −0.7) as a chromaticity in a L*a*b* expression in accordance with JIS Z8701-1999 (CIE1976). That is, the reflected color of the anti-glare layer surface formed on the polarizing plate preferably has a chromaticity which represents a slightly blue color. In the case where the chromaticity of the reflected light is in such a range, a reflected light of a light entered through the surface of the liquid crystal panel is partly absorbed in an ITO electrode or a wiring electrode by combination of the functional film and the liquid crystal panel, whereby the reflected light is prevented from changing from blue to yellow. As a result, the reflected-light chromaticity can be neutralized.

[Process for Producing Functional Film]

The functional film of the present invention can be produced by a step for forming an anti-reflective layer on an anti-glare layer (particularly, on an anti-glare layer formed on a substrate film).

(1) Process for Producing Anti-Glare Layer

The anti-glare layer may be produced by, for example, a step for coating (applying) a liquid coating composition (or a coating liquid or a mixture) containing the resin component (or to) a substrate (a substrate film) (a coating step) and a step for drying a coated layer (wet coated layer) formed by the coating step (a drying step). In particular, in the case of using a curable resin, the anti-glare layer may be produced by a step for coating (applying) a liquid coating composition (or a coating liquid or a mixture) containing the resin component and the curable resin (or to) a substrate (a substrate film) (a coating step), a step for drying a coated layer (wet coated layer) formed by the coating step (a drying step), and a step for curing the coated layer (dried coated layer) obtained by the drying step(a curing step). Incidentally, in the drying step phase separation of the plurality of resins usually occurs and forms an uneven surface structure.

Specifically, the functional layer may be produced by coating a substrate (substrate film) with a mixture (particularly, a mixed solution) containing the resin component, the curable resin, and a solvent, generating a phase separation in the wet coated layer in a step for drying the wet (undried) coated layer, and curing the dried layer. In the production process of the present invention, it is preferable that a solvent having a boiling point of not lower than 100° C. be used to generate the phase separation in the wet coated layer in the drying step and then the coated layer be cured. Incidentally, when a separable substrate is used as the substrate, the coated layer, which constitutes the anti-glare layer, may be separated from the substrate, and an anti-reflection layer may be formed on the anti-glare layer (anti-glare film).

(Use of Phase Separation)

In the present invention, typically, the phase separation structure of the resin component may form an uneven surface structure.

(Liquid Coating Composition)

In the present invention, the phase separation may be conducted by evaporating the solvent from the liquid coating composition (or mixture, particularly, solution). In particular, among the components contained in the mixture (particularly, solution), the solvent is absolutely necessary to generate the phase separation stably.

The solvent may be selected depending on the kinds and solubility of the resin component and curable resin to be used. In the case of a mixed solvent, it is sufficient that the solvent can uniformly dissolve at least one solid content (at least one component selected from the group of consisting of the resin component, the curable resin, a reaction initiator, and other additives). The solvent may include, for example, a ketone (e.g., acetone, methyl ethyl ketone, methyl isobutyl ketone, acetylacetone, acetoacetic acid ester, and cyclohexanone), an ether (e.g., diethyl ether, dioxane, and tetrahydrofuran), an aliphatic hydrocarbon (e.g., hexane), an alicyclic hydrocarbon (e.g., cyclohexane), an aromatic hydrocarbon (e.g., toluene and xylene), a carbon halide (e.g., dichloromethane and dichloroethane), an ester (e.g., methyl acetate, ethyl acetate, and butyl acetate), water, an alcohol (e.g., methanol, ethanol, propanol, isopropanol, butanol, cyclohexanol, diacetone alcohol, furfuryl alcohol, tetrahydrofurfuryl alcohol, ethylene glycol, propylene glycol, and hexylene glycol), a cellosolve (e.g., methyl cellosolve, ethyl cellosolve, butylcellosolve, diethylene glycol monomethyl ether, diethylene glycol monoethyl ether, and propylene glycol monomethyl ether), a cellosolve acetate, a sulfoxide (e.g., dimethyl sulfoxide), and an amide (e.g., dimethylformamide, and dimethyhlacetamide). These solvents may be used singly or in combination.

In the present invention, in order to allow such a phase separation to proceed stably, it is preferred to use a solvent having a boiling point of not lower than 100° C. at an atmospheric pressure (which is sometimes referred to as a high-boiling solvent) as a solvent. Further, to generate the convection cell, the solvent preferably comprises at least two solvent components with different boiling points. Moreover, the boiling point of the solvent component having a higher boiling point may be not lower than 100° C. and is usually about 100 to 200° C., preferably about 105 to 150° C. and more preferably about 110 to 130° C. In particular, in order to use convection cell in combination with phase separation, the solvent preferably comprises at least one solvent component having a boiling point of not lower than 100° C. and at least one solvent component having a boiling point of lower than 100° C. (for example, a solvent component having a boiling point of about 35 to 99° C., preferably about 40 to 95° C., and more preferably about 50 to 85° C.) in combination. In the evaporation of such a mixed solvent, the solvent component having a lower boiling point generates a temperature difference between the upper and lower regions (or layers) of the coated layer due to evaporation, and the solvent component having a higher boiling point remains in the coated layer resulting in keeping of fluidity.

The solvent (or solvent component) having a boiling point of not lower than 100° C. at an atmospheric pressure may include, for example, an alcohol (e.g., a C₄₋₈alkyl alcohol such as butanol, pentyl alcohol or hexyl alcohol), an alkoxy alcohol (e.g., a C₁₋₆alkoxyC₂₋₆alkyl alcohol such as methoxypropanol or butoxyethanol), an alkylene glycol (e.g., a C₂₋₄alkylene glycol such as ethylene glycol or propylene glycol), and a ketone (e.g., cyclohexanone). These solvents may be used singly or in combination. Among them, a C₄₋₈alkyl alcohol such as butanol, a C₁₋₆alkoxyC₂₋₆alkyl alcohol such as methoxypropanol or butoxyethanol, and a C₂₋₄alkylene glycol such as ethylene glycol are preferred. These solvents may be used singly or in combination.

The ratio of the solvent components with different boiling points is not particularly limited to a specific one. In the use of a solvent component having a boiling point of not lower than 100° C. (a first solvent component) in combination with a solvent component having a boiling point of lower than 100° C. (a second solvent component), the ratio of the first solvent component relative to the second component (when each of the first and second solvent components comprises a plurality of components, the ratio is defined as a weight ratio of the total first solvent components relative to the total second solvent components) may be, for example, about 5/95 to 70/30, preferably about 10/90 to 50/50, and more preferably about 15/85 to 40/60 (particularly about 20/80 to 40/60).

Moreover, when a liquid mixture or liquid coating composition is coated on a substrate (a transparent support), a solvent which does not dissolve, corrode or swell the transparent support may be selected according to the kinds of the transparent support. For example, when a triacetylcellulose film is employed as the transparent support, tetrahydrofuran, methyl ethyl ketone, isopropanol, toluene or the like is used as a solvent for the liquid mixture or the liquid coating composition and thus the functional layer can be formed without deteriorating properties of the film.

According to the present invention, in order to adjust the viscosity of the liquid coating composition (or mixture, particularly mixed solution) so that the shape of the uneven surface due to the convection is maintained and the generated convection circulates without stagnation, the solid content of the liquid coating composition may be, for example, about 5 to 50% by weight, preferably about 10 to 40% by weight, and more preferably about 15 to 35% by weight.

Incidentally, the proportion of the solid content in the liquid coating composition may be selected from the same range as that described above. For example, the proportion (weight ratio) of the resin component relative to the curable resin (the former/the latter) may be about 5/95 to 95/5, preferably about 5/95 to 80/20, more preferably about 10/90 to 70/30, and particularly about 15/85 to 60/40. In particular, in the resin component containing the cellulose derivative in whole or in part, the proportion (weight ratio) of the resin component relative to the curable resin (the former/the latter) may be about 10/90 to 80/20, preferably about 20/80 to 70/30, and more preferably about 30/70 to 60/40 (e.g., about 35/65 to 55/45).

(Coating Thickness)

The coating thickness of the mixture or solution (the thickness of the undried coated layer) may be, for example, about 10 to 200 μm, preferably about 15 to 100 μm, and more preferably about 20 to 50 μm.

(Coating Method)

The coating method may include a conventional manner, for example, a roll coater, an air knife coater, a blade coater, a rod coater, a reverse coater, a bar coater, a comma coater, a dip and squeeze coater, a die coater, a gravure coater, a microgravure coater, a silkscreen coater, a dipping method, a spraying method, and a spinner method. Among these methods, a bar coater or a gravure coater is used widely. In general, in the production of the anti-glare layer, cellular convection tends to be arranged in a machine direction (an MD direction of the film, or a moving direction of a coater such as bar coater).

(Drying Temperature)

After casting or coating the mixture (particularly, solution), the phase separation is preferably induced by evaporating the solvent at a temperature lower than the boiling point of the solvent [for example, at a temperature lower than a boiling point of a solvent having a higher boiling point by about 1 to 120° C. (preferably by about 5 to 80° C. and particularly by about 10 to 60° C.)]. For example, depending on the boiling point of the solvent, the coated layer may be dried at a temperature of about 30 to 200° C. (e.g., about 30 to 100° C.), preferably about 40 to 120° C., and more preferably about 50 to 100° C.

Moreover, the dry air flow rate is not particularly limited to a specific one. An excessively high air flow rate prompts phase separation excessively, whereby the vertical the difference in the vertical interval of the uneven surface structure becomes large. Such a large difference makes a uniform forming of the anti-reflection layer on the anti-glare layer difficult. Accordingly, the dry air flow rate may be not higher than 50 m/minute (e.g., about 1 to 50 m/minute), preferably about 1 to 30 m/minute, and more preferably about 1 to 20 m/minute. The angle of the dry wind blown against the anti-glare layer is not particularly limited to a specific one. For example, the angle may be parallel or perpendicular to the film.

(Curing Treatment)

After drying the mixture (solution), the coated layer is usually cured or crosslinked by heat or an actinic ray (e.g., an ultraviolet ray, and an electron beam). The curing process may be selected depending on the kinds of the curable resin, and a curing process by light irradiation such as an ultraviolet ray or an electron beam is usually employed. The widely used light source for exposure is usually an ultraviolet irradiation equipment. If necessary, light irradiation may be carried out under an inert gas atmosphere.

(2) Production Process of Anti-Reflection Layer

The anti-reflection layer is not particularly limited to a specific one as long as the anti-reflection layer may be formed on the anti-glare layer. The anti-reflection layer can be produced by a step for coating the anti-glare layer (particularly, the anti-glare layer formed on a substrate film) with a liquid coating composition containing the low-refractive-index particle and the high-refractive-index particle and a step for drying the resulting wet coated layer. Incidentally, in the drying step, the phase separation of the coating composition usually occurs, so that the low-refractive-index particle and the high-refractive-index particle are separately localized.

The anti-reflection layer can be usually produced by the following steps: a step for coating the anti-glare layer with a liquid coating composition (a coating liquid or a mixture) containing the low-refractive-index particle, the high-refractive-index particle, and a film forming component (such as the low-refractive-index resin), if necessary, other components (such as a polymerization initiator) and a solvent, or casting the liquid coating composition on the anti-glare layer (a coating step) and a step for drying a resulting wet coated layer (wet coated layer) (a drying step). In particular, in the case where the film-forming component is a heat- or photo-curable resin, the anti-reflection layer can be produced by a step for coating the anti-glare layer with the liquid coating composition (a coating liquid or a mixture) further containing the heat- or photo-curable resin as the film-forming component, a step for drying a resulting wet coated layer (wet coated layer) (a drying step), and a step for curing the coated layer resulted form the drying step (dried layer) (a curing step).

The solvent is not particularly limited to a specific one as long as the solvent can dissolve or disperse the low-refractive-index resin or the polymerization initiator and uniformly disperse the low-refractive-index particle or the high-refractive-index particle. The solvent exemplified in the paragraph concerning the anti-glare layer may be used. These solvents may be used alone or in combination. Moreover, the solvent may include, for example, a reactive diluent [e.g., a (meth)acrylic monomer such as a polyfunctional (meth)acrylate]. Such a solvent may be evaporated while the coating step. In the case where the solvent is a reactive diluent, the reactive diluent may be cured by polymerization while curing the curable resin precursor.

The solid content in the liquid coating composition (the coating liquid) may be, for example, about 1 to 10% by weight, preferably about 1.5 to 8% by weight, more preferably about 2 to 6% by weight (particularly about 2.5 to 5% by weight). A coating liquid having an excessively low solid content has a poor coatability. Therefore, the production of the anti-reflection film is difficult. A coating liquid having an excessively high solid content (i.e., having a large amount of the particle) tends to cause an aggregation of the particle.

Incidentally, the component constituting the anti-reflection layer can also be obtained in the form of a solution (a coating liquid). Such a coating liquid is available as, for example, “SH-1129SIC” manufactured by Catalysts & Chemicals Industries Co., Ltd.

The coating manner, drying manner, and curing manner in the production process of the anti-reflection layer are conducted by the manners similar to those in the production process of the anti-glare layer. Incidentally, as for the drying step, the adjustment required in the drying step in the production process of the anti-glare layer is unnecessary. The anti-reflection layer may be dried by a conventional manner at a predetermined temperature.

The thickness (dry thickness) of the coated layer may be, for example, about 0.01 to 30 μm, preferably about 0.05 to 20 μm, and more preferably about 0.1 to 8 μm.

Incidentally, in the case where the curable resin is used as the low-refractive-index resin, in the coating step, a liquid coating composition containing the curable resin in addition to the low-refractive-index particle and the high-refractive-index particle is used. When such a liquid coating composition containing the curable resin is used, the dried coated layer may usually be subjected to the curing step. In the curing step, according to kind of the curable resin, the curing may be conducted with irradiating with one member selected from the group of an actinic ray and heat. The curing manner to be usually employed may include an irradiation with a light beam such as an ultraviolet ray or an electron beam (an actinic ray irradiation). The widely used light beam source is usually an ultraviolet ray irradiation apparatus. Incidentally, the irradiation with a light beam may be conducted in an inert gas atmosphere.

[Optical Member]

The functional film of the present invention has uniform and high-definition (or high-grade) anti-glareness because of an uneven surface in which each raised part is uniformly controlled by phase separation and a low-refractive-index region having accumulated low-refractive index particle (a region formed by the localized low-refractive index particle) as the outermost layer. Further, the functional film of the present invention has a high abrasion resistance (hardcoat property) and substantially contains no scattering medium within the film. Accordingly, the functional film realizes a high light-room contrast without having a whitish tinge due to an ambient light. Therefore, the functional film of the present invention is suitable for application of an optical member or others, and the above-mentioned support may also comprise a transparent polymer film for forming various optical members. The functional film obtained in combination with the transparent polymer film may be directly used as an optical member, or may form an optical member in combination with an optical element [for example, a variety of optical elements to be disposed into a light path, e.g., a polarizing plate, an optical retardation plate (or phase plate), and a light guide plate (or light guide)]. That is, the functional film may be disposed or laminated on at least one light path surface of an optical element. For example, the functional film may be laminated on at least one surface of the optical retardation plate, or may be disposed or laminated on an emerging surface (or emerge surface) of the light guide plate.

Since the functional film has abrasion resistance, the functional film may serve as a protective film. The functional film of the present invention is, therefore, suitably used as at least one of two protective films for a polarizing plate to produce a laminate (optical member), that is, the functional film is laminated on at least one surface of a polarizing plate to produce a laminate (optical member).

### [Display Apparatus]

The functional film of the present invention can be utilized for various display apparatuses or devices such as a liquid crystal display (LCD) apparatus, a cathode ray tube display, a self-luminous display, an organic or inorganic EL display, a field emission display (FED), a surface-conduction electron-emitter display (SED), a rear projection television display, a plasma display (PDP), and a touch panel-equipped display device. These display apparatuses comprise the functional film or the optical member (particularly, e.g., a laminate of a polarizing plate and a functional film) as an optical element. In particular, the functional film can be preferably used for a liquid crystal display apparatus and others because the functional film can inhibit reflection even in the case of being attached to a large-screen liquid crystal display apparatus such as a high-definition or high-definitional liquid crystal display.

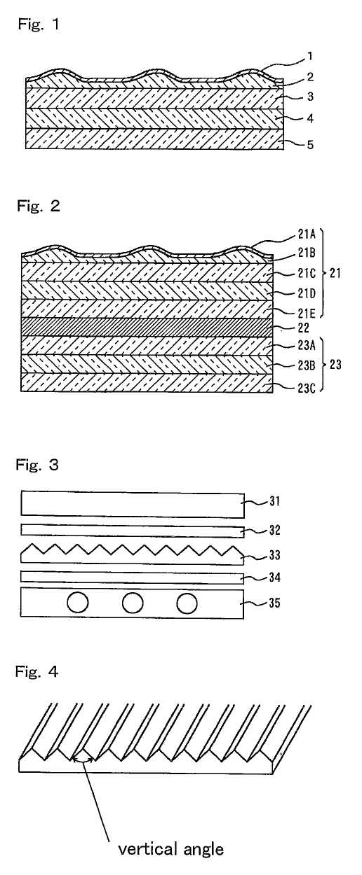

FIG. 1 is a schematic cross-sectional view of an optical member comprising a functional film in accordance with an embodiment of the present invention and a polarizing plate and having a laminated structure. The optical member comprises a polarizing layer 4, an anti-glare layer 2, and an anti-reflection layer 1. The polarizing layer 4 has protective layers 3 and 5 on both sides. The anti-glare layer 2 is formed on the protective layer 3. The anti-reflection layer 1 is formed on the anti-glare layer 2. In the optical member, the polarizing layer 4 is a film obtained by drawing a polyvinyl alcohol and dyeing the drawn polyvinyl alcohol with an iodine compound or a dye. Each of the protective layers 3 and 5 comprises a transparent resin, for example, a cellulose acetate-series resin such as a triacetylcellulose, a polyester-series resin, a polycarbonate-series resin, a polysulfone-series resin, a polyarylate-series resin, an acrylic resin such as a methyl methacrylate-series resin, and a cyclic polyolefinic resin such as a norbornene resin.

Incidentally, the liquid crystal display apparatus may be a reflection-mode (or reflective) liquid crystal display apparatus using an external light (or outside light) for illuminating a display unit comprising a liquid crystal cell, or may be a transmission-mode (or transmissive) liquid crystal display apparatus comprising a backlight unit for illuminating a display unit. In the reflection-mode liquid crystal display apparatus, the display unit can be illuminated by taking in an incident light from the outside through the display unit and reflecting the transmitted incident light by a reflective member. In the reflection-mode liquid crystal display apparatus, the anti-glare film or optical member (particularly a laminate of a polarizing plate and an anti-glare film) can be disposed in a light path in front of the reflective member. For example, the anti-glare film or optical member can be disposed or laminated, for example, between the reflective member and the display unit, or on the front surface of the display unit.

A transmissive liquid crystal display apparatus such as a liquid crystal television mainly employs a direct backlight unit. The backlight unit comprises a diffusion plate for the purpose of diffusing a light from a light source (e.g., a tubular light source such as a cold cathode tube or a hot cathode tube, and a point light source such as a light emitting diode) to make the brightness of the light uniform. Further, a prism sheet may be disposed on the front surface of the diffusion plate to increase the front luminance. The prism sheet has triangular prism units, each having a cross section which is an approximately isosceles triangle, and the units are arranged in parallel with each other to form a plurality of prism lines. The prism sheet comprises a transparent resin such as an olefinic resin (e.g., a cyclicolefin), a polycarbonate-series resin, or a poly(methyl methacrylate)-series resin. As the prism sheet, for example, “BEF series” manufactured by Sumitomo 3M Limited and others are commercially available. In the present invention, the prism sheet is not particularly limited to a specific one as long as the prism unit has a cross section which is an approximately isosceles triangle. A sheet having a sharp-pointed vertical angle of the isosceles triangle is preferable to a sheet having a rounded vertical angle of the isosceles triangle. Specifically, even in the case where the vertical angle is rounded, the radius of the curved surface may be, for example, not larger than 5 μm, and preferably not larger than 1 μm. The vertical angle is usually almost 90°.

Further, a reflective polarizing sheet may be disposed on the front surface of the prism sheet. The reflective polarizing sheet may be a multilayer membrane comprising a polyethylene-series resin and plays a role in the improvement of the effective utilization of the light reflected by the film. As the reflective polarizing sheet, for example, the trade name “DBEF” (manufactured by Sumitomo 3M Limited) and others have been put on the market.

In the liquid crystal display apparatus, the liquid crystal mode is not particularly limited to a specific one. For example, the liquid crystal mode may be a VA (Vertically Aligned) mode, a TN (Twisted Nematic) mode, an STN (Super Twisted Nematic) mode, an IPS mode (In-Plane Switching), and an OCB (Optical Compensated Bend) mode.

The functional film of the present invention comprises the anti-glare layer containing a resin phase-separate from other resin(s) and having an uneven surface structure and the low-refractive-index region containing the low-refractive-index particle (e.g., a hollow particle such as a hollow silica) and the high-refractive-index particle (e.g., an ATO particle). The combination of the anti-glare layer and the low-refractive-index region provides a high anti-glare property and anti-reflection property simultaneously

Such a functional film (or a display apparatus provided with the functional film) has the properties mentioned above, so that the reflection of an ambient light and glare are prevented (i.e., the film is exhibiting anti-glare property) and a black image (a high light-room contrast image) is allowed to be sharply displayed on the display under an ambient light.

Moreover, the functional film of the present invention attached to the display apparatus (such as a liquid crystal display) allows a light reflected on the display to be a neutral color tone. It is necessarily that the liquid crystal display apparatus (liquid crystal panel) provide an image which is bright (has a high luminance) and high-contrast. However, it has been difficult to improve the luminance by 1%. In the present invention, a combination use of the functional film of the present invention and a prism sheet having a vertex angle of almost 90° can remarkably improve the luminance by not less than 10%.

The present invention is useful for a variety of applications which require anti-glareness and a light-scattering property, e.g., for the above-mentioned optical member or display apparatus (or an optical element thereof) such as a liquid crystal display apparatus (in particular, a high-definition or high-definitional display apparatus). In particular, a combination use of the anti-glare film and the liquid crystal panel improves the light-room contrast and realizes a neutral reflected color in a display of black. Therefore, the anti-glare film of the present invention is particularly suitable as an anti-glare film used for a liquid crystal display apparatus, a PDP, an organic electroluminescence (EL), and others.

### EXAMPLES

The following examples are intended to describe this invention in further detail and should by no means be interpreted as defining the scope of the invention. Anti-glare films obtained in Examples and comparative Examples were evaluated by the following items.

[Haze]

The haze was measured by using a haze meter (manufactured by Nippon Denshoku Industries Co., Ltd., the trade name “NDH-5000W”).

[Image (Transmitted Image) Clarity]

The image clarity of the functional film was measured in accordance with JIS K7105 by using an image clarity measuring apparatus (manufactured by Suga Test Instruments Co., Ltd., the trade name “ICM-1DP”) provided with an optical slit (the slit width=0.5 mm). The image clarity was measured in the following method: the film was installed so that the machine direction of the film was parallel to the teeth direction of the optical slit.

[Average Inclination Angle]

The average inclination angle was measured, in accordance with JIS B0601 by using a contacting profiling surface texture and contour measuring instrument (manufactured by Tokyo Seimitsu Co., Ltd, trade name “surfcom570A”).

[Micrograph of Surface Structure and Mean Distance Between Two Adjacent Projections]

A black film was bonded on the backside of the functional film. A photograph of the uneven surface structure of the functional film was taken by using a laser reflecting microscope. Then the mean distance between two adjacent projections (pitch) based on the obtained photograph was calculated.

[Chromaticity of Reflected Color]

Each of anti-glare films obtained in Examples was measured for the chromaticity of the reflected color of L*a*b* color system (CIE 1976 (L*, a*, b*) color space, C light source, data interval: 5 nm) in accordance with color matching functions defined by JISZ8701-1999 (CIE1976). The measurement was conducted in accordance with a measuring method of total light reflection described in JIS K7105 by using a spectrophotometer (a trade name “V-560” manufactured by JASCO Corporation).

[Mounting Evaluation]

As shown in FIG. 2, a liquid crystal panel was made by bonding polarizing plates 21 and 23 on both sides of a liquid crystal cell 22, respectively, so that the absorption axes of these polarizing plates were at a right angle to each other. The polarizing plate 21 comprised an anti-reflection layer 21A, a functional layer 21B, a substrate film (protective layer) 21C, a polarizing layer 21D, and a protective layer 21E. The anti-reflection layer 21A and the functional layer 21B were laminated on a first side of the substrate film 21C, and the polarizing layer 21D and the protective layer 21E were laminated on a second side of the substrate film 21C. The polarizing plate 23 comprised a polarizing layer 23B, and protective layers 23A and 23C. The protective layers 23A and 23C were formed on first and second sides of the polarizing layer 23B, respectively.

Incidentally, the functional film shown in FIG. 2 corresponded to the functional film obtained in Example 1. In the meantime, in Comparative Example 1, the functional film shown in FIG. 2 corresponded to the functional film obtained in Comparative Example 1.

With the use of the liquid crystal panel, as shown in FIG. 3, a diffusion film 34, a prism sheet 33, a reflective polarizing film 32, and the liquid crystal panel 31 were arranged in this order on a backlight source 35, and a liquid crystal display apparatus comprising the liquid crystal panel and a drive circuit of a backlight was produced. That is, in the liquid crystal display apparatus, the functional film of the present invention and the polarizing plate 21 were laminated on a front side of the liquid crystal panel 31, and another polarizing plate 23 was laminated on a back side of the panel 31 so that the absorption axes of the polarizing plate and the polarizing layer were at a right angle to each other. In the liquid crystal display apparatus, a vertically aligned mode (VA mode) was applied as the liquid crystal mode. The liquid crystal panel of the vertically aligned mode displays a black display at the state that the in-plane phase difference is almost zero. By using such a liquid crystal display apparatus, a voltage was applied to the liquid crystal panel, and the following evaluation was made.

Incidentally, FIG. 4 shows a schematic perspective view of the prism sheet 33. In the sheet, the vertex angle of the isosceles triangle of the prism part is almost 900. For example, the trade name “BEFIII” manufactured by Sumitomo 3M Limited corresponds to such a prism sheet and is commercially available. On the other hand, as a prism sheet having a rounded vertical angle of the isosceles triangle, the trade name “RBEF” manufactured by Sumitomo 3M Limited is commercially available.

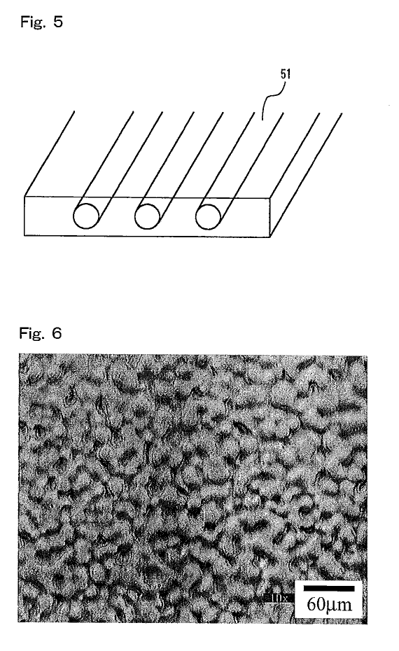

Moreover, FIG. 5 shows a schematic perspective view of the backlight source 35. This backlight source is a direct backlight unit in which tubular light sources 51 are disposed in parallel with each other.

(Anti-Glareness)

A fluorescent lamp having an exposed (uncovered) fluorescent tube was used. The reflected light of the lamp on the panel surface was visually observed, and the blurring of the reflected outline of the fluorescent tube was evaluated on the basis of the following criteria.

“A”: No reflected outline of the fluorescent lamp is observed.

“B”: The reflected outline of the fluorescent lamp is slightly observed, but it is negligible.

“C”. The reflected outline of the fluorescent lamp is observed, and it is slightly considerable.

“D”: The strongly reflected outline of the fluorescent lamp is observed, and it is very considerable.

(Darkness of Reflected Image)

An observer's face was reflected on the panel surface in a light-room environment. The reflected image was visually observed, and the darkness of the reflected image and the distinction of the facial features were evaluated on the basis of the following criteria.

“A”: The reflected image of the face is sufficiently dark, and no reflected outline of the face is observed.

“B”: The reflected image of the face is slightly observed, but the facial features cannot be distinguished.

“C”: The reflected image of the face is observed, and the facial features are distinguished.

“D”: The strongly reflected image of the face is observed, and is very considerable.

(Blackness)

The liquid crystal panel was installed so that the surface of the panel was almost perpendicular to the floor. In a light-room environment having an illuminance of not less than 500 lux (lx) and having white walls on either side of the panel, the surface of the panel in a state of the black display was visually observed whether the surface appeared black, and evaluated on the basis of the following criteria.

“A”: The surface sufficiently appears black.

“B”: The surface appears black.

“C”: The surface does not appear very black.

“D”: The surface hardly appears black.

(Uniformity of Reflection)

A light of fluorescent light was reflected on the liquid crystal panel surface. The uniformity of the chromaticity of the reflected light was observed visually and evaluated based on the following criteria.

“A”: Uniform chromaticity and no color uniformity

“B”: Slight color nonuniformity but negligible

“C”: Slight negligible color nonuniformity

“D”: Considerable color nonuniformity

### Example 1

In a mixed solvent containing 10 parts by weight of methyl ethyl ketone (MEK) (boiling point: 80° C.), 2 parts by weight of 1-butanol (BuOH) (boiling point: 113° C.) and 1.5 parts by weight of 1-methoxy-2-propanol (boiling point: 119° C.) were dissolved 4.5 parts by weight of an acrylic resin having a polymerizable unsaturated group(s) in a side chain thereof [manufactured by Daicel Chemical Industries, Ltd., “CYCLOMER-P”], 0.5 part by weight of a cellulose acetate propionate (acetylation degree=2.5%, propionylation degree=46%, number average molecular weight in terms of polystyrene: 75,000; manufactured by Eastman, Ltd., “CAP-482-20”), 5.2 parts by weight of a polyfunctional acrylic UV-curable monomer (manufactured by DAICEL-CYTEC Company, Ltd., “DPHA”), 1 part by weight of a polyfunctional acrylic UV-curable monomer (manufactured by DAICEL-CYTEC Company, Ltd., “PETIA”), 2.5 parts by weight of a polyfunctional hybrid UV-curing agent (manufactured by JSR Corporation, “Z7501”), 0.35 part by weight of a photopolymerization initiator (manufactured by Ciba Specialty Chemicals K.K., “IRGACURE 184”) and 0.15 part by weight of a photopolymerization initiator (manufactured by Ciba Specialty Chemicals K.K., “IRGACURE 907”). The mixture was used as a coating solution for an anti-glare layer. Incidentally, the cellulose acetate propionate and the acrylic resin are incompatible with each other, and the concentration of the resulting solution is accompanied by phase separability. The solution was coated on a cellulose triacetate film by a continuous mechanical coating. The coating manner was a microgravure manner. A coat layer having a thickness of about 11 μm and an uneven surface was formed by using a drying furnace that was separately controllable of a drying condition of a first zone and that of a second zone. After drying by the drying furnace, the obtained coat layer was subjected to UV curing treatment for about 30 seconds by irradiating ultraviolet rays from a metal halide lump (manufactured by Eyegraphics Co., Ltd.) to form an anti-glare film having hardcoat property and an uneven surface structure.

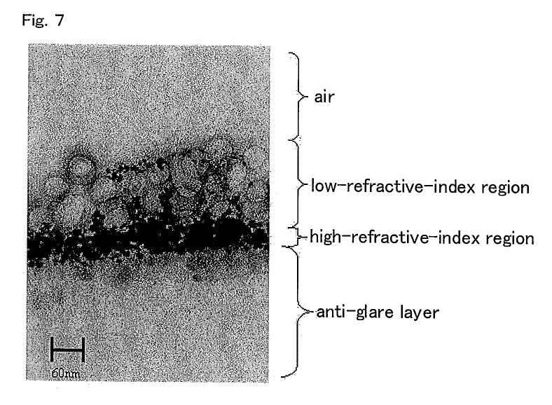

Further, on the anti-glare layer of the film, a coating liquid for forming an anti-reflection layer (manufactured by Catalysts & Chemicals Industries Co., Ltd., trade name “SH-1129SIC”, which was a UV-curable coating material containing a hollow silica and an ATO (an isopropyl alcohol solution containing 1.5% by weight of a hollow silica fine particle having a mean particle diameter of 60 nm and a refractive index (n) of 1.23, an ATO fine particle having a mean particle diameter of 5 nm and a refractive index (n) of 1.67, and 0.9% by weight of a UV-curable resin component comprising pentaerythritol as a main component) was coated by using a coating machine. After the coated layer was dried, the resulting coated layer was subjected to UV curing treatment for about 30 seconds by irradiating ultraviolet rays from a metal halide lump (manufactured by Eyegraphics Co., Ltd.) to form an anti-reflection layer having a thickness of about 150 nm. Thus a functional film was produced. The characteristics of the obtained film are shown in Table 1. Further, the laser reflection microphotograph of the uneven surface of the film is shown in FIG. 6. As apparent from FIG. 6, it is clear that the uneven surface is formed by phase separation. Moreover, the transmission electron microscope (TEM) photograph of the cross section of the obtained film is shown in FIG. 7. The TEM photograph shows a particle-localized region in which the ATO particle is localized near the anti-glare layer. Incidentally, the thickness of the high-refractive-index region calculated from the photograph was 26 nm. The thickness of the high-refractive-index region was obtained as follows: taking five TEM photographs of the cross section of the obtained film; measuring each of the photographs for the thickness of a region containing 80% of all the high-refractive-index particles in the anti-reflection layer from the second surface of the anti-reflection layer; and calculating an average value of the obtained thicknesses.

Incidentally, also in the mounting evaluation of Comparative Example 1, a sheet (brand name “RBEF” manufactured by Sumitomo 3M Limited) was used as a prism sheet.

### Comparative Example 1

An ATO-containing UV curable coating material (trade name “ELCOM P-3560”) for a high-refractive-index region was coated on the anti-glare layer obtained in Example 1 using a wire bar #4. Incidentally, the coating material comprised 0.3% by weight of an ATO fine particle having a mean particle diameter of 5 nm and a refractive index (n) of 1.67 and 1.2% by weight of an UV curable resin component. After drying the coated layer, the layer was subjected to UV hardening for about 30 seconds by an irradiation with an ultraviolet ray from a metal halide lamp (manufactured by Eeygraphics Co., Ltd) to form a high-refractive-index region having a thickness of about 30 nm. A hollow silica-containing UV curable coating material for a low-refractive-index region was coated on the high-refractive-index region using a wire bar #5. Incidentally, the coating material comprised 1.67% by weight of a surface-treated hollow silica fine particle having a mean particle diameter of 60 nm and a refractive index (n) of 1.23 and 1.33% by weight of an UV curable resin component. After drying the coated layer, the layer was subjected to UV hardening for about 30 seconds by an irradiation with an ultraviolet ray from a metal halide lamp (manufactured by Eyegraphics Co., Ltd) to form a high-refractive-index region having a thickness of about 100 nm. In this manner, an anti-glare film was produced.

Incidentally, in the mounting evaluation concerning Comparative Example 1, a sheet (trade name “RBEF” manufactured by Sumitomo 3M Limited) was used as a prism sheet.

The properties of films obtained in Example 1 and Comparative Example 1 are shown in Table 1.

TABLE 1

| | | Comparative |
|---|---|---|
| | Example 1 | Example 1 |
| Minimum reflectance | 0.9% | 1.3% |
| Haze | 3.5% | 3.1% |
| Chromaticity | a* = 1.1356 | a* = −4.458 |
| | b* = −1.6517 | b* = −8.848 |
| Anti-glareness | A | A |
| Blackness | A | C |
| Darkness of reflected | A | C |
| image | | |
| Uniformity of reflection | A | D |

What is claimed is:

1. A functional film comprising an anti-glare layer and an anti-reflection layer formed on the anti-glare layer, wherein the anti-glare layer comprises a resin component comprising a plurality of resins which phase-separate from each other, the anti-reflection layer has a first surface and a second surface contacting with the anti-glare layer and comprises a low-refractive-index particle and a high-refractive-index particle, and the high-refractive-index particle is localized near the second surface of the anti-reflection layer.

2. A functional film according to claim 1, wherein the anti-glare layer is a cured layer obtained by curing a coating layer comprising a resin component and a curable resin and has an uneven surface structure.

3. A functional film according to claim 1, wherein the plurality of resins comprises at least a cellulose derivative.

4. A functional film according to claim 1, wherein at least one polymer of the plurality of resins is a polymer having a functional group reactive with a curable resin.

5. A functional film according to claim 1, wherein the plurality of resins comprises a cellulose ester and a resin having a functional group reactive with a curable resin at a side chain thereof and the resin is at least one resin selected from the group consisting of a (meth)acrylic resin, an alicyclic olefinic resin, and a polyester-series resin.

6. A functional film according to claim 1, wherein the low-refractive-index particle comprises a hollow silica particle.

7. A functional film according to claim 1, wherein the low-refractive-index particle has a mean particle diameter of 50 to 70 nm and a refractive index of 1.20 to 1.25.

8. A functional film according to claim 1, wherein the high-refractive-index particle comprises at least one member selected from the group consisting of an antimony-containing tin oxide particle and an antimony(V) oxide particle.

9. A functional film according to claims 1, wherein the high-refractive-index particle has a mean particle diameter of 5 to 30 nm and a refractive index of 1.60 to 1.80.

10. A functional film according to claim 1, wherein the weight ratio of the low-refractive-index particle relative with the high-refractive-index particle is 93/7 to 50/50.

11. A functional film according to claim 1, wherein the anti-reflection layer has a high-refractive-index region formed by the localized high-refractive-index particle near the second surface of the anti-reflection layer and a low-refractive-index region in which a low-refractive-index particle is localized near the first surface of the anti-reflection layer, the thickness of the high-refractive-index region is about 5 to 40 nm, and the thickness of the low-refractive-index region is about 90 to 120 nm.

12. A functional film according to claim 11, wherein the high-refractive-index region comprises the low-refractive-index particle.

13. A functional film according to claim 1, wherein the anti-reflection layer comprises a low-refractive-index resin as a resin component or a film-forming resin, and the low-refractive-index resin comprises a curable resin having a (meth)acryloyl group.

14. A process for producing a functional film recited in claim 1, which comprises
a coating step for coating a substrate film having an anti-glare layer recited in claim 1 formed thereon with a liquid coating composition containing a low-refractive-index particle and a high-refractive-index particle and
a drying step for drying the resulting coating layer.

15. A process according to claim 14, which further comprises a step for curing the dried coating layer by irradiating with one selected from the group consisting of an actinic ray and heat, wherein the liquid coating composition further comprises a curable resin as a low-refractive-index resin.

16. A display apparatus provided with a functional film recited in claim 1.
